(19) United States
(12) Patent Application Publication
(10) Pub. No.: US 2007/0231149 A1
(43) Pub. Date: Oct. 4, 2007

(54) OPTIMIZED GUIDE VANE, GUIDE VANE RING SECTOR, COMPRESSION STAGE, COMPRESSOR AND TURBOMACHINE COMPRISING SUCH A VANE

(75) Inventors: Claire Jacqueline Aynes, Vert Saint Denis (FR); Evelyne Ginette Boutteville, Chennevieres Sur Marne (FR); Thierry Jean Maurice Niclot, Savigny Sur Orge (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/693,172

(22) Filed: Mar. 29, 2007

(30) Foreign Application Priority Data
Mar. 30, 2006 (FR) 06 02738

(51) Int. Cl. B64C 27/46

(52) U.S. Cl. 416/223 R

(57) ABSTRACT

The invention relates to a novel optimized aerodynamic profile for a vane. It provides a novel type of guide vane ring sector for which an optimization of the shape and a local arrangement of the geometry of the vanes have been made, allowing the level of stress in the brazed joint linking the vane to its outer shroud to be reduced, while still meeting the aerodynamic and mechanical requirements imposed on the vane.

### BACKGROUND OF THE INVENTION AND DESCRIPTION OF THE PRIOR ART

The invention relates to the field of turbomachines, especially turbojet engines, and to guide vanes placed within a compressor.

It relates more precisely to a novel optimized aerodynamic profile of a vane so as to meet the aerodynamic and mechanical requirements imposed on the vane.

In the rest of the description, the terms “upstream” or “downstream” will be used to denote the positions of the structural elements relative to one another in the axial direction, taking as reference the gas flow direction. Likewise, the terms “inner” or “radially inner” and “outer” or “radially outer” will be used to denote the positions of the structural elements relative to one another in the radial direction, taking as reference the rotation axis of the turbomachine.

A turbomachine comprises one or more compressors delivering pressurized air to a combustion chamber where the air is mixed with fuel and ignited so as to generate hot combustion gases. These gases flow toward the downstream end of the chamber into one or more turbines that convert the energy thus received, so as to rotate the compressor(s) and thus deliver the necessary work, for example for driving an aircraft.

A compressor, for example a high-pressure compressor, consists of one or more compression stages each comprising a stator vane ring followed by a rotor wheel fitted with moving blades. The stator vane ring, also called a guide vane ring, may be composed of an assembly of angular guide vane ring sectors, one example of which is illustrated in FIG. 1, each sector 1 having a plurality of stationary vanes 2 joined via their inner end to an inner shroud 3 and via their outer end to an outer shroud 4. The role of the guide vane ring sectors is to direct the stream of air arriving from upstream of the engine so that this stream upstream of the rotor wheel strikes it at the appropriate angle.

The vanes 2 are defined by two sidewalls called, respectively, pressure surface 8 and suction surface 9 and forming an aerodynamic profile with a leading edge and a trailing edge. The leading edge 6 or LE is formed by the upstream join between the pressure surface and the suction surface. The trailing edge 7 or TE is formed by the downstream join between the pressure surface and the suction surface. This aerodynamic profile is very important as it allows the guide vane to direct the incoming stream of air from upstream of the turbomachine in the desired manner. This profile is defined by computation in the form of radial sections, made along the stacking axis of the vane, denoted by E in the figure, at different heights relative to the turbomachine rotation axis. The vane formed by these various radial sections is then integrated between the inner and outer shrouds. The vane and the shrouds may then be assembled by brazing.

For certain aerodynamic profiles, the radius of curvature of the TE is so small, for example of the order of one tenth of a millimeter, that this causes, during operation of the engine, an increase in the static stress in the brazed joint formed between the vane and the outer shroud, on the pressure surface side, toward the TE. The level of stress thus reached may prove to be unacceptable and be the origin of cracks appearing in the brazed joint. In order for the vane to meet the aerodynamic and mechanic requirements imposed on it, it is necessary to find a novel aerodynamic profile that makes it possible to reduce the level of stress in the brazed joint and has no deleterious effect on the aerodynamic and mechanical characteristics of the vane.

### SUMMARY OF THE INVENTION

The invention solves this problem by providing a novel optimized aerodynamic profile for a guide vane.

This novel profile, obtained by simulations and iterations between aerodynamic calculations and mechanical calculations, makes it possible to ensure the mechanical integrity of the guide vane ring sectors and to meet the aerodynamic requirements associated with directing the airstream. In addition, this novel type of guide vane assembly is perfectly interchangeable with an old guide vane assembly without having any impact on the interfaces between the components surrounding the guide vane assembly.

More particularly, the invention relates to a turbomachine guide vane, the vane having an aerodynamic profile and a stacking axis E, the turbomachine having a rotation axis R, the vane being noteworthy in that it consists of a plurality of radial sections made orthogonally to its stacking axis E, each radial section being composed of points whose Cartesian coordinates X, Y and Z are as defined in Table 1, the Z coordinate corresponding to the distance between a radial section in question and the turbomachine rotation axis R, X and Y corresponding to the coordinates in the plane comprising the section in question of the points forming this section, the X axis being parallel to the turbomachine rotation axis R, the X values increasing in the turbomachine gas flow direction, the origin of the X axis being located at its intersection with the Z axis, the Y axis being such that the (X,Y,Z) reference frame is a direct orthogonal frame.

According to one embodiment of the invention, each radial section has a center of gravity, the X and Y Cartesian coordinates of which are given in FIG. 5.

Preferably, each radial section has a leading edge and a trailing edge, the value of the direct angle formed by the straight line joining the leading edge to the trailing edge and the Y axis following the curve given in FIG. 7.

The invention furthermore relates to a guide vane ring sector comprising an inner shroud, an outer shroud and at least one such vane. It also relates to a compression stage, to a compressor and to a turbomachine that are provided with at least one such guide vane ring sector.

### DESCRIPTION OF THE DRAWINGS

The invention will be better understood and other advantages thereof will become more clearly apparent in the light of the following description of a preferred embodiment, given by way of example but implying no limitation, and with reference to the appended drawings in which:

FIG. 1 is a perspective view of a guide vane ring sector, seen from upstream, according to the prior art;

FIG. 2 is a schematic sectional view of a turbomachine and more precisely of an aircraft turbojet engine;

FIG. 3 is a sectional view of a guide vane ring sector in a plane that includes the rotation axis R of the turbomachine, according to the invention;

FIG. 4 is a detailed view of a guide vane assembly according to the invention, seen from the pressure surface;

FIG. 5 is a graph in two dimensions, representing the coordinates XG and YG of the centers of gravity of the various constituent radial sections of a vane according to the invention;

FIG. 6 is a top view of a radial section along the A-A axis of a vane according to the invention, placed in the (X,Y,Z) reference frame; and

FIG. 7 is a graph in two dimensions representing the value of the setting in degrees of a vane according to the invention for the various constituent radial sections of the vane.

### DESCRIPTION OF THE PREFERRED EMBODIMENT

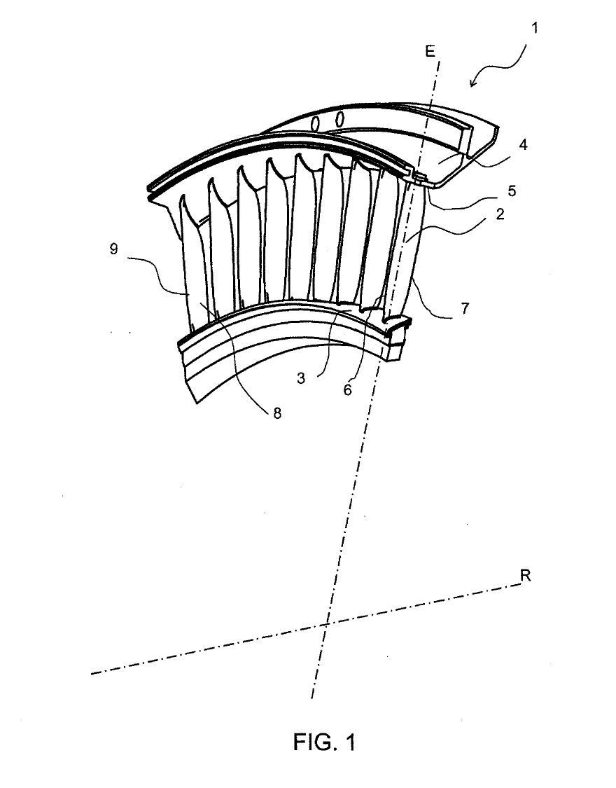

FIG. 1, already described, shows, seen from upstream, a guide vane ring sector 1 comprising a plurality of vanes 2.

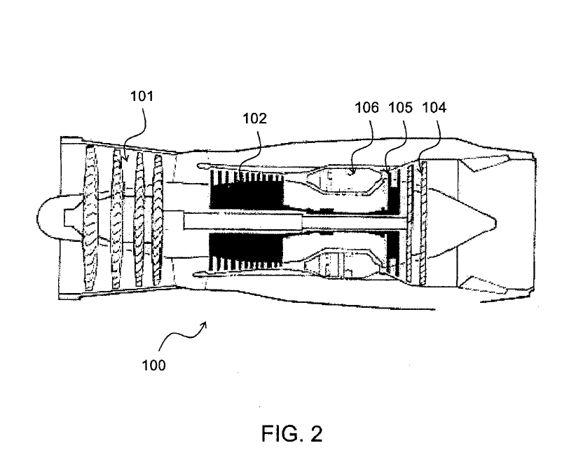

FIG. 2 shows, in cross section, an overall view of a turbomachine 100, for example an aircraft turbojet engine, comprising a low-pressure compressor 101, a high-pressure compressor 102, a low-pressure turbine 104, a high-pressure turbine 105 and a combustion chamber 106.

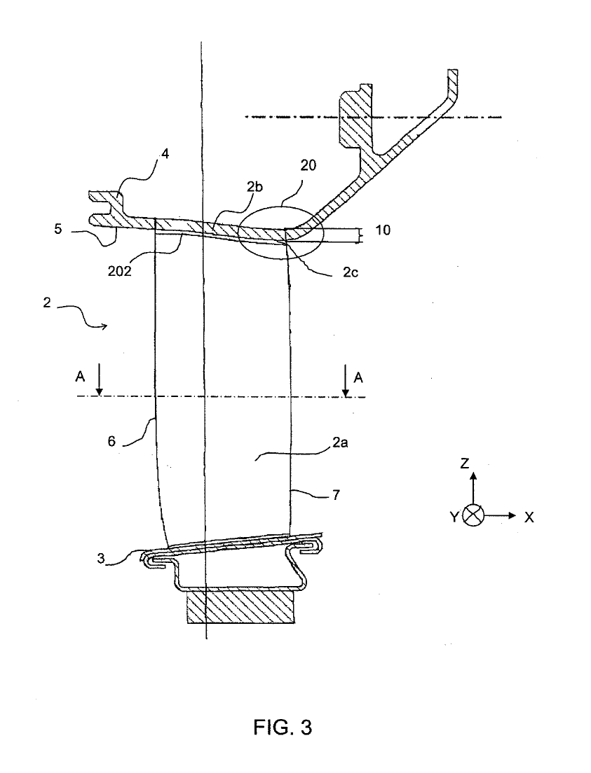

FIG. 3 shows a guide vane ring sector according to the invention, seen in cross section in a plane containing the rotation axis R of the turbomachine.

The vane 2 is made up of a radially outer part 10 and a radially inner part 2a. The radially outer part 10, also called the tip of the vane, is made up of a joining part 2b and an intermediate part 2c.

The vane 2 is embedded radially in the outer shroud 4 via its radially outer part 10 and more precisely thanks to its joining part 2b. In the example illustrated here, the radially outer part 10 is a cylinder, the generatrices of which are parallel to the stacking axis E of the vane 2. The surface 202 corresponds to the boundary between the radially inner part 2a and the radially outer part 10 of the vane.

The vane 2 and the outer shroud 4 are assembled by brazing, the brazed joint being produced between the outer shroud 4 and the joining part 2b of the vane. When the radius of curvature of the trailing edge 7 is very small, for example around 0.2 mm, a local overstress may appear in the brazed joint, on the pressure side, toward the TE, and may be the origin of cracks. The area where this possible overstress is located corresponds to that identified by 20. In this area, a particular arrangement of the shape of the blade is produced, so as to meet the mechanical strength requirements in the brazed joint and in the vane.

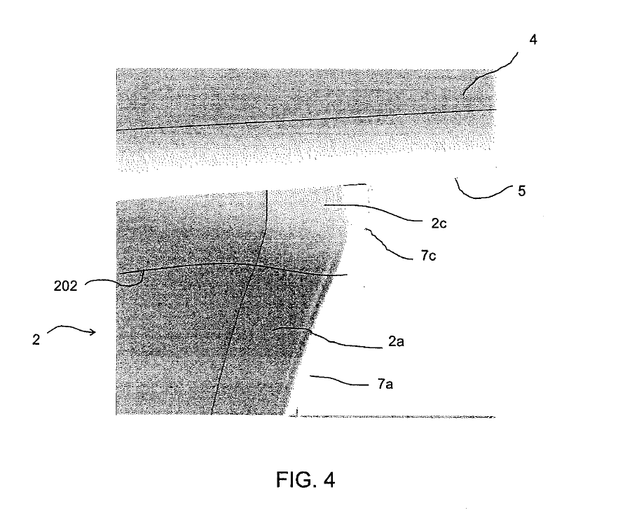

FIG. 4 shows a detailed view on the pressure surface side of the area 20 of a vane 2 according to the invention.

The radially inner part 2a of the vane 2 has a radius of curvature of the TE 7a joining the pressure surface 8 to the suction surface 9 that is practically constant from the inner shroud 3 as far as the cutting surface 202.

Beyond this, the radius of curvature of the TE 7c changes. It increases from a value identical to the radius 7a up to a value that may be equal to three times the value of the radius 7a, this value being a maximum beyond which the effect on the level and location of the overstress is no longer significant.

In addition, the increase in radius of curvature of the TE is accompanied by an increase in the thickness of the vane. This increase may be over the entire chord length of the vane, but generally only a downstream part of the vane has an increased thickness. The chord length is the length of the line joining the leading edge to the trailing edge of the vane, for a given radial section. Preferably, the part having its thickness increased represents at most one third of the chord length for a radial section in question. The increase in thickness of the section is gradual so that no shape irregularity or protuberance will disturb the flow of air over the pressure surface.

Finally, in the joining part 2b, the radius of curvature of the TE is identical to the radius of curvature of the intermediate part 2c.

To define the shape of the vane corresponding to the invention and meeting the various abovementioned requirements, namely the airstream-directing quality and mechanical integrity requirements, there is only one set of optimum geometric loci. This set of geometric loci is determined by iterations between aerodynamic and mechanical calculations and defines the entire shape of the vane 2 between the inner 3 and outer 4 shrouds.

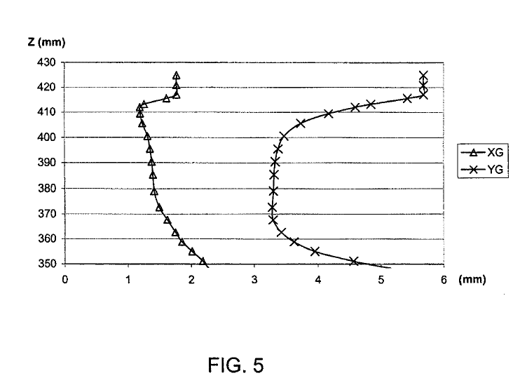

This set of geometric loci is represented in the form of radial sections taken at different heights, relative to the turbomachine rotation axis R, which are orthogonal to the stacking axis E of the vane 2. Each radial section is itself defined by its center of gravity G and by a set of ninety-nine points. The center of gravity and each point on each radial section are identified by their X and Y coordinates given in a direct orthogonal reference frame (X,Y,Z). For each of the various radial sections, the set of Cartesian coordinates of the centers of gravity is given in FIG. 5 and the set of Cartesian coordinates of their points is given below in Table 1. The values of the X, Y and Z coordinates are given in millimeters.

The Z axis of the reference frame corresponds to the stacking axis E of the vane 2, the values of the Z coordinates increasing upon going away from the axis R and its origin being located at its intersection with the axis R. The X axis is parallel to the axis R, the X values increasing toward the downstream end of the turbomachine, its origin being located at its intersection with the Z axis, that is to say with the stacking axis E. The direction and sense of the Y axis are obtained naturally from the fact that the reference frame (X,Y,Z) is a direct orthogonal reference frame, the origin of the Y axis being located at its intersection with the stacking axis E.

FIG. 5 is a graph giving, for each value of Z defining the vane 2, the coordinates XG and YG of the center of gravity of the corresponding radial section. This graph comprises two curves, that on the left corresponding to the values of the coordinates XG of the centers of gravity and that on the right to the values of the coordinates YG.

TABLE 1
X and Y coordinates per radial section

| | | |
|---|---|---|
| X | Y | Z |

Radial section 00

| | | |
|---|---|---|
| −7.39 | −7.80 | 347.38 |
| −7.40 | −7.80 | 347.38 |
| −7.41 | −7.79 | 347.38 |
| −7.42 | −7.77 | 347.38 |
| −7.44 | −7.75 | 347.38 |
| −7.45 | −7.71 | 347.38 |
| −7.46 | −7.65 | 347.38 |
| −7.46 | −7.58 | 347.38 |
| −7.45 | −7.50 | 347.38 |
| −7.44 | −7.40 | 347.38 |
| −7.36 | −7.08 | 347.38 |
| −7.23 | −6.65 | 347.38 |
| −7.04 | −6.11 | 347.38 |
| −6.79 | −5.45 | 347.38 |
| −6.48 | −4.68 | 347.38 |
| −6.09 | −3.79 | 347.38 |
| −5.63 | −2.81 | 347.38 |
| −5.08 | −1.73 | 347.38 |
| −4.46 | −0.57 | 347.38 |
| −3.74 | 0.65 | 347.38 |
| −2.93 | 1.91 | 347.38 |
| −2.03 | 3.20 | 347.38 |
| −1.03 | 4.49 | 347.38 |
| 0.06 | 5.76 | 347.38 |
| 1.23 | 6.99 | 347.38 |
| 2.47 | 8.16 | 347.38 |
| 3.76 | 9.25 | 347.38 |
| 5.10 | 10.26 | 347.38 |
| 6.44 | 11.18 | 347.38 |
| 7.78 | 12.01 | 347.38 |
| 9.08 | 12.76 | 347.38 |
| 10.32 | 13.43 | 347.38 |
| 11.50 | 14.03 | 347.38 |
| 12.58 | 14.56 | 347.38 |
| 13.56 | 15.03 | 347.38 |
| 14.44 | 15.43 | 347.38 |
| 15.19 | 15.78 | 347.38 |
| 15.83 | 16.08 | 347.38 |
| 16.35 | 16.32 | 347.38 |
| 16.76 | 16.51 | 347.38 |
| 17.06 | 16.66 | 347.38 |
| 17.15 | 16.70 | 347.38 |
| 17.23 | 16.73 | 347.38 |
| 17.30 | 16.73 | 347.38 |
| 17.35 | 16.71 | 347.38 |
| 17.38 | 16.68 | 347.38 |
| 17.41 | 16.66 | 347.38 |
| 17.42 | 16.64 | 347.38 |
| 17.43 | 16.63 | 347.38 |
| 17.43 | 16.62 | 347.38 |
| 17.44 | 16.61 | 347.38 |
| 17.44 | 16.60 | 347.38 |
| 17.45 | 16.58 | 347.38 |
| 17.45 | 16.55 | 347.38 |
| 17.45 | 16.51 | 347.38 |
| 17.44 | 16.45 | 347.38 |
| 17.40 | 16.40 | 347.38 |
| 17.34 | 16.35 | 347.38 |
| 17.25 | 16.30 | 347.38 |
| 16.97 | 16.15 | 347.38 |
| 16.59 | 15.94 | 347.38 |
| 16.11 | 15.66 | 347.38 |
| 15.52 | 15.32 | 347.38 |
| 14.82 | 14.91 | 347.38 |
| 14.02 | 14.42 | 347.38 |
| 13.13 | 13.85 | 347.38 |
| 12.15 | 13.22 | 347.38 |
| 11.09 | 12.50 | 347.38 |
| 9.97 | 11.71 | 347.38 |
| 8.80 | 10.85 | 347.38 |
| 7.60 | 9.91 | 347.38 |
| 6.38 | 8.90 | 347.38 |
| 5.16 | 7.83 | 347.38 |
| 3.96 | 6.70 | 347.38 |
| 2.78 | 5.54 | 347.38 |
| 1.65 | 4.35 | 347.38 |
| 0.57 | 3.14 | 347.38 |
| −0.44 | 1.92 | 347.38 |
| −1.37 | 0.72 | 347.38 |
| −2.23 | −0.46 | 347.38 |
| −3.02 | −1.58 | 347.38 |
| −3.73 | −2.64 | 347.38 |
| −4.38 | −3.62 | 347.38 |
| −4.95 | −4.50 | 347.38 |
| −5.46 | −5.29 | 347.38 |
| −5.90 | −5.96 | 347.38 |
| −6.28 | −6.53 | 347.38 |
| −6.60 | −6.99 | 347.38 |
| −6.85 | −7.35 | 347.38 |
| −7.05 | −7.60 | 347.38 |
| −7.12 | −7.67 | 347.38 |
| −7.17 | −7.72 | 347.38 |
| −7.23 | −7.77 | 347.38 |
| −7.27 | −7.79 | 347.38 |
| −7.31 | −7.81 | 347.38 |
| −7.34 | −7.81 | 347.38 |
| −7.36 | −7.81 | 347.38 |
| −7.38 | −7.81 | 347.38 |
| −7.39 | −7.80 | 347.38 |

Radial section 03

| | | |
|---|---|---|
| −8.33 | −7.10 | 351.17 |
| −8.33 | −7.09 | 351.17 |
| −8.34 | −7.08 | 351.17 |
| −8.36 | −7.07 | 351.17 |
| −8.37 | −7.04 | 351.17 |
| −8.39 | −7.00 | 351.17 |
| −8.39 | −6.94 | 351.17 |
| −8.39 | −6.88 | 351.17 |
| −8.38 | −6.80 | 351.17 |
| −8.36 | −6.70 | 351.17 |
| −8.26 | −6.40 | 351.17 |
| −8.11 | −5.99 | 351.17 |
| −7.89 | −5.49 | 351.17 |
| −7.60 | −4.87 | 351.17 |
| −7.24 | −4.15 | 351.17 |
| −6.79 | −3.33 | 351.17 |
| −6.26 | −2.43 | 351.17 |
| −5.64 | −1.45 | 351.17 |
| −4.92 | −0.40 | 351.17 |
| −4.10 | 0.70 | 351.17 |
| −3.20 | 1.83 | 351.17 |
| −2.19 | 2.96 | 351.17 |
| −1.10 | 4.10 | 351.17 |
| 0.08 | 5.20 | 351.17 |
| 1.33 | 6.26 | 351.17 |
| 2.63 | 7.26 | 351.17 |
| 3.98 | 8.19 | 351.17 |
| 5.36 | 9.03 | 351.17 |
| 6.73 | 9.80 | 351.17 |
| 8.08 | 10.49 | 351.17 |
| 9.39 | 11.12 | 351.17 |
| 10.63 | 11.68 | 351.17 |
| 11.80 | 12.18 | 351.17 |
| 12.88 | 12.62 | 351.17 |
| 13.85 | 13.02 | 351.17 |
| 14.72 | 13.36 | 351.17 |
| 15.47 | 13.66 | 351.17 |
| 16.10 | 13.91 | 351.17 |
| 16.61 | 14.12 | 351.17 |
| 17.01 | 14.28 | 351.17 |
| 17.30 | 14.41 | 351.17 |
| 17.39 | 14.44 | 351.17 |
| 17.47 | 14.46 | 351.17 |
| 17.54 | 14.45 | 351.17 |
| 17.59 | 14.43 | 351.17 |
| 17.62 | 14.41 | 351.17 |
| 17.64 | 14.38 | 351.17 |
| 17.65 | 14.36 | 351.17 |
| 17.66 | 14.35 | 351.17 |
| 17.67 | 14.34 | 351.17 |
| 17.67 | 14.34 | 351.17 |
| 17.67 | 14.32 | 351.17 |
| 17.68 | 14.30 | 351.17 |
| 17.68 | 14.27 | 351.17 |
| 17.68 | 14.23 | 351.17 |
| 17.67 | 14.18 | 351.17 |
| 17.63 | 14.13 | 351.17 |
| 17.57 | 14.08 | 351.17 |
| 17.49 | 14.04 | 351.17 |
| 17.21 | 13.90 | 351.17 |
| 16.83 | 13.72 | 351.17 |
| 16.35 | 13.48 | 351.17 |
| 15.77 | 13.18 | 351.17 |
| 15.08 | 12.81 | 351.17 |
| 14.29 | 12.38 | 351.17 |
| 13.40 | 11.88 | 351.17 |
| 12.42 | 11.31 | 351.17 |
| 11.36 | 10.68 | 351.17 |
| 10.23 | 9.99 | 351.17 |
| 9.05 | 9.24 | 351.17 |
| 7.82 | 8.42 | 351.17 |
| 6.57 | 7.55 | 351.17 |
| 5.31 | 6.63 | 351.17 |
| 4.05 | 5.66 | 351.17 |
| 2.81 | 4.65 | 351.17 |
| 1.60 | 3.62 | 351.17 |
| 0.45 | 2.57 | 351.17 |
| −0.65 | 1.51 | 351.17 |
| −1.68 | 0.46 | 351.17 |
| −2.64 | −0.57 | 351.17 |
| −3.51 | −1.56 | 351.17 |
| −4.31 | −2.50 | 351.17 |
| −5.04 | −3.37 | 351.17 |
| −5.68 | −4.16 | 351.17 |
| −6.24 | −4.86 | 351.17 |
| −6.73 | −5.47 | 351.17 |
| −7.15 | −5.98 | 351.17 |
| −7.49 | −6.39 | 351.17 |
| −7.76 | −6.71 | 351.17 |
| −7.98 | −6.94 | 351.17 |
| −8.05 | −7.00 | 351.17 |
| −8.11 | −7.04 | 351.17 |
| −8.17 | −7.08 | 351.17 |
| −8.21 | −7.10 | 351.17 |
| −8.25 | −7.11 | 351.17 |
| −8.28 | −7.11 | 351.17 |
| −8.30 | −7.10 | 351.17 |
| −8.32 | −7.10 | 351.17 |
| −8.33 | −7.10 | 351.17 |

Radial section 07

| | | |
|---|---|---|
| −9.11 | −6.63 | 354.97 |
| −9.12 | −6.62 | 354.97 |
| −9.13 | −6.61 | 354.97 |
| −9.14 | −6.60 | 354.97 |
| −9.16 | −6.57 | 354.97 |
| −9.17 | −6.53 | 354.97 |
| −9.17 | −6.48 | 354.97 |
| −9.17 | −6.41 | 354.97 |
| −9.15 | −6.33 | 354.97 |
| −9.13 | −6.24 | 354.97 |
| −9.02 | −5.95 | 354.97 |
| −8.85 | −5.56 | 354.97 |
| −8.61 | −5.08 | 354.97 |
| −8.29 | −4.49 | 354.97 |
| −7.89 | −3.81 | 354.97 |
| −7.40 | −3.04 | 354.97 |
| −6.82 | −2.19 | 354.97 |
| −6.14 | −1.27 | 354.97 |
| −5.37 | −0.29 | 354.97 |
| −4.49 | 0.71 | 354.97 |
| −3.51 | 1.74 | 354.97 |
| −2.43 | 2.77 | 354.97 |
| −1.27 | 3.78 | 354.97 |
| −0.02 | 4.76 | 354.97 |
| 1.29 | 5.69 | 354.97 |
| 2.65 | 6.55 | 354.97 |
| 4.05 | 7.35 | 354.97 |
| 5.46 | 8.06 | 354.97 |
| 6.86 | 8.70 | 354.97 |
| 8.23 | 9.28 | 354.97 |
| 9.56 | 9.79 | 354.97 |
| 10.81 | 10.25 | 354.97 |
| 11.99 | 10.66 | 354.97 |
| 13.07 | 11.03 | 354.97 |
| 14.05 | 11.35 | 354.97 |
| 14.92 | 11.63 | 354.97 |
| 15.67 | 11.88 | 354.97 |
| 16.30 | 12.08 | 354.97 |
| 16.82 | 12.26 | 354.97 |
| 17.22 | 12.39 | 354.97 |
| 17.52 | 12.49 | 354.97 |
| 17.61 | 12.52 | 354.97 |
| 17.68 | 12.53 | 354.97 |
| 17.75 | 12.52 | 354.97 |
| 17.80 | 12.49 | 354.97 |
| 17.83 | 12.47 | 354.97 |
| 17.84 | 12.44 | 354.97 |
| 17.85 | 12.42 | 354.97 |
| 17.86 | 12.41 | 354.97 |
| 17.86 | 12.40 | 354.97 |
| 17.87 | 12.39 | 354.97 |
| 17.87 | 12.38 | 354.97 |
| 17.87 | 12.36 | 354.97 |
| 17.88 | 12.33 | 354.97 |
| 17.87 | 12.29 | 354.97 |
| 17.86 | 12.24 | 354.97 |
| 17.82 | 12.19 | 354.97 |
| 17.76 | 12.14 | 354.97 |
| 17.67 | 12.11 | 354.97 |
| 17.39 | 11.99 | 354.97 |
| 17.02 | 11.83 | 354.97 |
| 16.53 | 11.63 | 354.97 |
| 15.94 | 11.37 | 354.97 |
| 15.25 | 11.05 | 354.97 |
| 14.45 | 10.67 | 354.97 |
| 13.55 | 10.23 | 354.97 |
| 12.56 | 9.74 | 354.97 |
| 11.49 | 9.19 | 354.97 |
| 10.34 | 8.59 | 354.97 |
| 9.14 | 7.93 | 354.97 |
| 7.88 | 7.22 | 354.97 |
| 6.59 | 6.46 | 354.97 |
| 5.29 | 5.66 | 354.97 |
| 3.99 | 4.81 | 354.97 |
| 2.70 | 3.93 | 354.97 |
| 1.43 | 3.03 | 354.97 |
| 0.21 | 2.10 | 354.97 |
| −0.95 | 1.17 | 354.97 |
| −2.05 | 0.23 | 354.97 |
| −3.07 | −0.69 | 354.97 |
| −4.00 | −1.58 | 354.97 |
| −4.86 | −2.43 | 354.97 |
| −5.63 | −3.22 | 354.97 |
| −6.32 | −3.95 | 354.97 |
| −6.92 | −4.60 | 354.97 |
| −7.44 | −5.15 | 354.97 |
| −7.88 | −5.62 | 354.97 |
| −8.25 | −6.00 | 354.97 |
| −8.54 | −6.30 | 354.97 |
| −8.76 | −6.50 | 354.97 |
| −8.83 | −6.55 | 354.97 |
| −8.90 | −6.59 | 354.97 |
| −8.95 | −6.62 | 354.97 |
| −9.00 | −6.64 | 354.97 |
| −9.04 | −6.65 | 354.97 |
| −9.07 | −6.64 | 354.97 |
| −9.09 | −6.64 | 354.97 |
| −9.10 | −6.63 | 354.97 |
| −9.11 | −6.63 | 354.97 |

Radial section 10

| | | |
|---|---|---|
| −9.64 | −6.31 | 358.77 |
| −9.64 | −6.30 | 358.77 |
| −9.65 | −6.29 | 358.77 |
| −9.67 | −6.28 | 358.77 |
| −9.68 | −6.25 | 358.77 |
| −9.69 | −6.21 | 358.77 |
| −9.69 | −6.16 | 358.77 |
| −9.69 | −6.09 | 358.77 |
| −9.67 | −6.02 | 358.77 |
| −9.64 | −5.93 | 358.77 |
| −9.53 | −5.64 | 358.77 |
| −9.34 | −5.26 | 358.77 |
| −9.08 | −4.79 | 358.77 |
| −8.75 | −4.22 | 358.77 |
| −8.33 | −3.56 | 358.77 |
| −7.81 | −2.81 | 358.77 |
| −7.19 | −1.99 | 358.77 |
| −6.48 | −1.11 | 358.77 |
| −5.66 | −0.19 | 358.77 |
| −4.74 | 0.77 | 358.77 |
| −3.72 | 1.75 | 358.77 |
| −2.60 | 2.71 | 358.77 |
| −1.40 | 3.65 | 358.77 |
| −0.11 | 4.56 | 358.77 |
| 1.24 | 5.41 | 358.77 |
| 2.63 | 6.20 | 358.77 |
| 4.05 | 6.91 | 358.77 |
| 5.49 | 7.56 | 358.77 |
| 6.91 | 8.13 | 358.77 |
| 8.29 | 8.64 | 358.77 |
| 9.63 | 9.10 | 358.77 |
| 10.89 | 9.50 | 358.77 |
| 12.08 | 9.86 | 358.77 |
| 13.16 | 10.18 | 358.77 |
| 14.15 | 10.46 | 358.77 |
| 15.02 | 10.70 | 358.77 |
| 15.78 | 10.92 | 358.77 |
| 16.41 | 11.10 | 358.77 |
| 16.93 | 11.25 | 358.77 |
| 17.33 | 11.37 | 358.77 |
| 17.63 | 11.46 | 358.77 |
| 17.72 | 11.49 | 358.77 |
| 17.80 | 11.49 | 358.77 |
| 17.86 | 11.48 | 358.77 |
| 17.91 | 11.45 | 358.77 |
| 17.93 | 11.42 | 358.77 |
| 17.95 | 11.40 | 358.77 |
| 17.96 | 11.38 | 358.77 |
| 17.97 | 11.37 | 358.77 |
| 17.97 | 11.36 | 358.77 |
| 17.97 | 11.35 | 358.77 |
| 17.98 | 11.34 | 358.77 |
| 17.98 | 11.32 | 358.77 |
| 17.98 | 11.29 | 358.77 |
| 17.98 | 11.25 | 358.77 |
| 17.96 | 11.20 | 358.77 |
| 17.92 | 11.15 | 358.77 |
| 17.86 | 11.11 | 358.77 |
| 17.77 | 11.08 | 358.77 |
| 17.49 | 10.97 | 358.77 |
| 17.11 | 10.83 | 358.77 |
| 16.62 | 10.64 | 358.77 |
| 16.03 | 10.40 | 358.77 |
| 15.33 | 10.11 | 358.77 |
| 14.53 | 9.76 | 358.77 |
| 13.62 | 9.36 | 358.77 |
| 12.62 | 8.90 | 358.77 |
| 11.54 | 8.40 | 358.77 |
| 10.38 | 7.84 | 358.77 |
| 9.16 | 7.23 | 358.77 |
| 7.89 | 6.58 | 358.77 |
| 6.58 | 5.88 | 358.77 |
| 5.26 | 5.14 | 358.77 |
| 3.93 | 4.36 | 358.77 |
| 2.60 | 3.55 | 358.77 |
| 1.31 | 2.71 | 358.77 |
| 0.05 | 1.86 | 358.77 |
| −1.15 | 0.99 | 358.77 |
| −2.29 | 0.13 | 358.77 |
| −3.35 | −0.74 | 358.77 |
| −4.32 | −1.57 | 358.77 |
| −5.21 | −2.37 | 358.77 |
| −6.02 | −3.11 | 358.77 |
| −6.73 | −3.80 | 358.77 |
| −7.36 | −4.41 | 358.77 |
| −7.91 | −4.94 | 358.77 |
| −8.37 | −5.38 | 358.77 |
| −8.75 | −5.74 | 358.77 |
| −9.05 | −6.01 | 358.77 |
| −9.28 | −6.20 | 358.77 |
| −9.36 | −6.25 | 358.77 |
| −9.42 | −6.29 | 358.77 |
| −9.48 | −6.32 | 358.77 |
| −9.53 | −6.33 | 358.77 |
| −9.57 | −6.33 | 358.77 |
| −9.60 | −6.33 | 358.77 |
| −9.62 | −6.32 | 358.77 |
| −9.63 | −6.31 | 358.77 |
| −9.64 | −6.31 | 358.77 |

Radial section 16

| | | |
|---|---|---|
| −9.96 | −6.08 | 362.57 |
| −9.97 | −6.07 | 362.57 |
| −9.98 | −6.07 | 362.57 |
| −9.99 | −6.05 | 362.57 |
| −10.01 | −6.02 | 362.57 |
| −10.02 | −5.98 | 362.57 |
| −10.02 | −5.93 | 362.57 |
| −10.01 | −5.86 | 362.57 |
| −9.99 | −5.79 | 362.57 |
| −9.97 | −5.70 | 362.57 |
| −9.85 | −5.41 | 362.57 |
| −9.66 | −5.04 | 362.57 |
| −9.39 | −4.58 | 362.57 |
| −9.04 | −4.02 | 362.57 |
| −8.60 | −3.37 | 362.57 |
| −8.06 | −2.64 | 362.57 |
| −7.43 | −1.85 | 362.57 |
| −6.69 | −0.99 | 362.57 |
| −5.85 | −0.10 | 362.57 |
| −4.90 | 0.83 | 362.57 |
| −3.85 | 1.76 | 362.57 |
| −2.70 | 2.69 | 362.57 |
| −1.47 | 3.58 | 362.57 |
| −0.16 | 4.44 | 362.57 |
| 1.21 | 5.25 | 362.57 |
| 2.62 | 5.98 | 362.57 |
| 4.06 | 6.65 | 362.57 |
| 5.51 | 7.25 | 362.57 |
| 6.94 | 7.78 | 362.57 |
| 8.33 | 8.25 | 362.57 |
| 9.67 | 8.67 | 362.57 |
| 10.94 | 9.04 | 362.57 |
| 12.13 | 9.37 | 362.57 |
| 13.22 | 9.67 | 362.57 |
| 14.21 | 9.92 | 362.57 |
| 15.08 | 10.15 | 362.57 |
| 15.84 | 10.35 | 362.57 |
| 16.47 | 10.51 | 362.57 |
| 16.99 | 10.66 | 362.57 |
| 17.40 | 10.77 | 362.57 |
| 17.69 | 10.85 | 362.57 |
| 17.78 | 10.87 | 362.57 |
| 17.86 | 10.88 | 362.57 |
| 17.93 | 10.86 | 362.57 |
| 17.97 | 10.84 | 362.57 |
| 18.00 | 10.81 | 362.57 |
| 18.02 | 10.78 | 362.57 |
| 18.02 | 10.76 | 362.57 |
| 18.03 | 10.75 | 362.57 |
| 18.03 | 10.74 | 362.57 |
| 18.03 | 10.73 | 362.57 |
| 18.04 | 10.72 | 362.57 |
| 18.04 | 10.70 | 362.57 |
| 18.04 | 10.67 | 362.57 |
| 18.04 | 10.63 | 362.57 |
| 18.02 | 10.58 | 362.57 |
| 17.98 | 10.53 | 362.57 |
| 17.92 | 10.49 | 362.57 |
| 17.83 | 10.46 | 362.57 |
| 17.55 | 10.36 | 362.57 |
| 17.17 | 10.22 | 362.57 |
| 16.68 | 10.04 | 362.57 |
| 16.09 | 9.82 | 362.57 |
| 15.38 | 9.54 | 362.57 |
| 14.58 | 9.21 | 362.57 |
| 13.67 | 8.82 | 362.57 |
| 12.67 | 8.39 | 362.57 |
| 11.58 | 7.91 | 362.57 |
| 10.41 | 7.37 | 362.57 |
| 9.18 | 6.80 | 362.57 |
| 7.90 | 6.17 | 362.57 |
| 6.59 | 5.51 | 362.57 |
| 5.25 | 4.80 | 362.57 |
| 3.90 | 4.07 | 362.57 |
| 2.56 | 3.30 | 362.57 |
| 1.25 | 2.51 | 362.57 |
| −0.03 | 1.70 | 362.57 |
| −1.26 | 0.88 | 362.57 |
| −2.42 | 0.05 | 362.57 |
| −3.50 | −0.76 | 362.57 |
| −4.50 | −1.56 | 362.57 |
| −5.42 | −2.32 | 362.57 |
| −6.25 | −3.03 | 362.57 |
| −6.99 | −3.69 | 362.57 |
| −7.63 | −4.27 | 362.57 |
| −8.19 | −4.78 | 362.57 |
| −8.67 | −5.20 | 362.57 |
| −9.06 | −5.55 | 362.57 |
| −9.36 | −5.81 | 362.57 |
| −9.60 | −5.99 | 362.57 |
| −9.68 | −6.04 | 362.57 |
| −9.75 | −6.07 | 362.57 |
| −9.81 | −6.09 | 362.57 |
| −9.86 | −6.11 | 362.57 |
| −9.90 | −6.11 | 362.57 |
| −9.92 | −6.10 | 362.57 |
| −9.94 | −6.09 | 362.57 |
| −9.95 | −6.09 | 362.57 |
| −9.96 | −6.08 | 362.57 |

Radial section 24

| | | |
|---|---|---|
| −10.27 | −5.90 | 367.63 |
| −10.27 | −5.89 | 367.63 |
| −10.28 | −5.88 | 367.63 |
| −10.29 | −5.87 | 367.63 |
| −10.31 | −5.84 | 367.63 |
| −10.32 | −5.80 | 367.63 |
| −10.32 | −5.75 | 367.63 |
| −10.32 | −5.68 | 367.63 |
| −10.30 | −5.61 | 367.63 |
| −10.27 | −5.52 | 367.63 |
| −10.15 | −5.23 | 367.63 |
| −9.95 | −4.86 | 367.63 |
| −9.68 | −4.40 | 367.63 |
| −9.32 | −3.85 | 367.63 |
| −8.88 | −3.21 | 367.63 |
| −8.32 | −2.49 | 367.63 |
| −7.67 | −1.71 | 367.63 |
| −6.91 | −0.87 | 367.63 |
| −6.05 | 0.01 | 367.63 |
| −5.08 | 0.91 | 367.63 |
| −4.01 | 1.81 | 367.63 |
| −2.84 | 2.71 | 367.63 |
| −1.58 | 3.57 | 367.63 |
| −0.25 | 4.40 | 367.63 |
| 1.14 | 5.17 | 367.63 |
| 2.57 | 5.87 | 367.63 |
| 4.03 | 6.50 | 367.63 |
| 5.49 | 7.06 | 367.63 |
| 6.93 | 7.56 | 367.63 |
| 8.33 | 8.00 | 367.63 |
| 9.68 | 8.39 | 367.63 |
| 10.96 | 8.74 | 367.63 |
| 12.15 | 9.04 | 367.63 |
| 13.25 | 9.32 | 367.63 |
| 14.24 | 9.56 | 367.63 |
| 15.12 | 9.77 | 367.63 |
| 15.87 | 9.95 | 367.63 |
| 16.51 | 10.11 | 367.63 |
| 17.03 | 10.24 | 367.63 |
| 17.44 | 10.35 | 367.63 |
| 17.74 | 10.43 | 367.63 |
| 17.83 | 10.45 | 367.63 |
| 17.91 | 10.45 | 367.63 |
| 17.97 | 10.43 | 367.63 |
| 18.02 | 10.41 | 367.63 |
| 18.04 | 10.38 | 367.63 |
| 18.06 | 10.35 | 367.63 |
| 18.07 | 10.33 | 367.63 |
| 18.07 | 10.32 | 367.63 |
| 18.08 | 10.31 | 367.63 |
| 18.08 | 10.30 | 367.63 |
| 18.08 | 10.29 | 367.63 |
| 18.08 | 10.27 | 367.63 |
| 18.08 | 10.24 | 367.63 |
| 18.08 | 10.20 | 367.63 |
| 18.06 | 10.15 | 367.63 |
| 18.02 | 10.10 | 367.63 |
| 17.96 | 10.06 | 367.63 |
| 17.87 | 10.04 | 367.63 |
| 17.59 | 9.94 | 367.63 |
| 17.21 | 9.81 | 367.63 |
| 16.72 | 9.63 | 367.63 |
| 16.12 | 9.41 | 367.63 |
| 15.41 | 9.14 | 367.63 |
| 14.60 | 8.82 | 367.63 |
| 13.69 | 8.45 | 367.63 |
| 12.69 | 8.03 | 367.63 |
| 11.59 | 7.56 | 367.63 |
| 10.42 | 7.05 | 367.63 |
| 9.18 | 6.49 | 367.63 |
| 7.89 | 5.89 | 367.63 |
| 6.57 | 5.25 | 367.63 |
| 5.21 | 4.57 | 367.63 |
| 3.85 | 3.86 | 367.63 |
| 2.50 | 3.13 | 367.63 |
| 1.17 | 2.37 | 367.63 |
| −0.13 | 1.59 | 367.63 |
| −1.38 | 0.80 | 367.63 |
| −2.56 | 0.01 | 367.63 |
| −3.66 | −0.77 | 367.63 |
| −4.69 | −1.54 | 367.63 |
| −5.63 | −2.27 | 367.63 |
| −6.47 | −2.96 | 367.63 |
| −7.23 | −3.59 | 367.63 |
| −7.89 | −4.16 | 367.63 |
| −8.46 | −4.65 | 367.63 |
| −8.95 | −5.06 | 367.63 |
| −9.34 | −5.40 | 367.63 |
| −9.66 | −5.65 | 367.63 |
| −9.90 | −5.82 | 367.63 |
| −9.98 | −5.87 | 367.63 |
| −10.05 | −5.90 | 367.63 |
| −10.11 | −5.92 | 367.63 |
| −10.16 | −5.93 | 367.63 |
| −10.20 | −5.93 | 367.63 |
| −10.23 | −5.92 | 367.63 |
| −10.25 | −5.91 | 367.63 |
| −10.26 | −5.90 | 367.63 |
| −10.26 | −5.90 | 367.63 |

Radial section 31

| | | |
|---|---|---|
| −10.48 | −5.81 | 372.69 |
| −10.49 | −5.81 | 372.69 |
| −10.50 | −5.80 | 372.69 |
| −10.51 | −5.78 | 372.69 |
| −10.52 | −5.75 | 372.69 |
| −10.53 | −5.71 | 372.69 |
| −10.54 | −5.66 | 372.69 |
| −10.53 | −5.59 | 372.69 |
| −10.52 | −5.52 | 372.69 |
| −10.49 | −5.43 | 372.69 |
| −10.37 | −5.14 | 372.69 |
| −10.17 | −4.77 | 372.69 |
| −9.90 | −4.31 | 372.69 |
| −9.54 | −3.75 | 372.69 |
| −9.09 | −3.11 | 372.69 |
| −8.53 | −2.39 | 372.69 |
| −7.87 | −1.61 | 372.69 |
| −7.11 | −0.78 | 372.69 |
| −6.23 | 0.10 | 372.69 |
| −5.25 | 0.99 | 372.69 |
| −4.17 | 1.89 | 372.69 |
| −2.99 | 2.78 | 372.69 |
| −1.72 | 3.64 | 372.69 |
| −0.37 | 4.45 | 372.69 |
| 1.03 | 5.20 | 372.69 |
| 2.48 | 5.89 | 372.69 |
| 3.95 | 6.51 | 372.69 |
| 5.42 | 7.05 | 372.69 |
| 6.87 | 7.53 | 372.69 |
| 8.28 | 7.96 | 372.69 |
| 9.64 | 8.33 | 372.69 |
| 10.93 | 8.66 | 372.69 |
| 12.13 | 8.96 | 372.69 |
| 13.23 | 9.22 | 372.69 |
| 14.23 | 9.45 | 372.69 |
| 15.11 | 9.65 | 372.69 |
| 15.88 | 9.82 | 372.69 |
| 16.52 | 9.97 | 372.69 |
| 17.04 | 10.10 | 372.69 |
| 17.45 | 10.20 | 372.69 |
| 17.76 | 10.28 | 372.69 |
| 17.85 | 10.30 | 372.69 |
| 17.92 | 10.30 | 372.69 |
| 17.99 | 10.29 | 372.69 |
| 18.03 | 10.26 | 372.69 |
| 18.06 | 10.23 | 372.69 |
| 18.07 | 10.20 | 372.69 |
| 18.08 | 10.18 | 372.69 |
| 18.09 | 10.17 | 372.69 |
| 18.09 | 10.16 | 372.69 |
| 18.09 | 10.15 | 372.69 |
| 18.10 | 10.14 | 372.69 |
| 18.10 | 10.12 | 372.69 |
| 18.10 | 10.09 | 372.69 |
| 18.09 | 10.05 | 372.69 |
| 18.07 | 10.00 | 372.69 |
| 18.03 | 9.95 | 372.69 |
| 17.97 | 9.91 | 372.69 |
| 17.88 | 9.89 | 372.69 |
| 17.60 | 9.79 | 372.69 |
| 17.21 | 9.66 | 372.69 |
| 16.72 | 9.49 | 372.69 |
| 16.12 | 9.28 | 372.69 |
| 15.41 | 9.01 | 372.69 |
| 14.60 | 8.69 | 372.69 |
| 13.68 | 8.33 | 372.69 |
| 12.67 | 7.91 | 372.69 |
| 11.57 | 7.45 | 372.69 |
| 10.39 | 6.95 | 372.69 |
| 9.15 | 6.40 | 372.69 |
| 7.85 | 5.81 | 372.69 |
| 6.51 | 5.18 | 372.69 |
| 5.15 | 4.51 | 372.69 |
| 3.78 | 3.81 | 372.69 |
| 2.42 | 3.08 | 372.69 |
| 1.07 | 2.34 | 372.69 |
| −0.24 | 1.58 | 372.69 |
| −1.49 | 0.80 | 372.69 |
| −2.69 | 0.02 | 372.69 |
| −3.81 | −0.75 | 372.69 |
| −4.84 | −1.51 | 372.69 |
| −5.79 | −2.23 | 372.69 |
| −6.65 | −2.91 | 372.69 |
| −7.41 | −3.54 | 372.69 |
| −8.08 | −4.10 | 372.69 |
| −8.66 | −4.59 | 372.69 |
| −9.15 | −5.00 | 372.69 |
| −9.55 | −5.33 | 372.69 |
| −9.87 | −5.58 | 372.69 |
| −10.12 | −5.75 | 372.69 |
| −10.20 | −5.79 | 372.69 |
| −10.27 | −5.82 | 372.69 |
| −10.33 | −5.84 | 372.69 |
| −10.38 | −5.84 | 372.69 |
| −10.42 | −5.84 | 372.69 |
| −10.44 | −5.83 | 372.69 |
| −10.46 | −5.82 | 372.69 |
| −10.47 | −5.82 | 372.69 |
| −10.48 | −5.81 | 372.69 |
| −10.58 | −5.74 | 379.02 |
| −10.59 | −5.73 | 379.02 |
| −10.60 | −5.72 | 379.02 |
| −10.61 | −5.70 | 379.02 |
| −10.62 | −5.68 | 379.02 |
| −10.64 | −5.64 | 379.02 |
| −10.64 | −5.59 | 379.02 |
| −10.64 | −5.52 | 379.02 |
| −10.62 | −5.44 | 379.02 |
| −10.60 | −5.35 | 379.02 |
| −10.48 | −5.07 | 379.02 |
| −10.28 | −4.69 | 379.02 |
| −10.01 | −4.23 | 379.02 |
| −9.65 | −3.67 | 379.02 |
| −9.20 | −3.02 | 379.02 |
| −8.65 | −2.30 | 379.02 |
| −7.99 | −1.52 | 379.02 |
| −7.23 | −0.68 | 379.02 |
| −6.35 | 0.20 | 379.02 |
| −5.36 | 1.09 | 379.02 |
| −4.27 | 1.99 | 379.02 |
| −3.09 | 2.87 | 379.02 |
| −1.81 | 3.72 | 379.02 |
| −0.46 | 4.53 | 379.02 |
| 0.96 | 5.27 | 379.02 |
| 2.41 | 5.95 | 379.02 |
| 3.89 | 6.56 | 379.02 |
| 5.37 | 7.09 | 379.02 |
| 6.83 | 7.56 | 379.02 |
| 8.25 | 7.98 | 379.02 |
| 9.61 | 8.34 | 379.02 |
| 10.91 | 8.66 | 379.02 |
| 12.11 | 8.95 | 379.02 |
| 13.22 | 9.20 | 379.02 |
| 14.22 | 9.42 | 379.02 |
| 15.11 | 9.62 | 379.02 |
| 15.87 | 9.79 | 379.02 |
| 16.52 | 9.94 | 379.02 |
| 17.05 | 10.06 | 379.02 |
| 17.46 | 10.16 | 379.02 |
| 17.76 | 10.24 | 379.02 |
| 17.85 | 10.26 | 379.02 |
| 17.93 | 10.26 | 379.02 |
| 17.99 | 10.24 | 379.02 |
| 18.04 | 10.21 | 379.02 |
| 18.06 | 10.18 | 379.02 |
| 18.08 | 10.16 | 379.02 |
| 18.09 | 10.14 | 379.02 |
| 18.09 | 10.13 | 379.02 |
| 18.10 | 10.12 | 379.02 |
| 18.10 | 10.11 | 379.02 |
| 18.10 | 10.10 | 379.02 |
| 18.10 | 10.07 | 379.02 |
| 18.10 | 10.05 | 379.02 |
| 18.10 | 10.01 | 379.02 |
| 18.08 | 9.96 | 379.02 |
| 18.04 | 9.91 | 379.02 |
| 17.97 | 9.87 | 379.02 |
| 17.89 | 9.84 | 379.02 |
| 17.60 | 9.75 | 379.02 |
| 17.22 | 9.62 | 379.02 |
| 16.73 | 9.45 | 379.02 |
| 16.12 | 9.23 | 379.02 |
| 15.41 | 8.97 | 379.02 |
| 14.60 | 8.65 | 379.02 |
| 13.68 | 8.29 | 379.02 |
| 12.67 | 7.87 | 379.02 |
| 11.57 | 7.41 | 379.02 |
| 10.39 | 6.91 | 379.02 |
| 9.14 | 6.36 | 379.02 |
| 7.84 | 5.77 | 379.02 |
| 6.50 | 5.14 | 379.02 |
| 5.13 | 4.48 | 379.02 |
| 3.76 | 3.79 | 379.02 |
| 2.39 | 3.07 | 379.02 |
| 1.04 | 2.33 | 379.02 |
| −0.28 | 1.57 | 379.02 |
| −1.54 | 0.81 | 379.02 |
| −2.74 | 0.04 | 379.02 |
| −3.87 | −0.73 | 379.02 |
| −4.91 | −1.48 | 379.02 |
| −5.86 | −2.20 | 379.02 |
| −6.72 | −2.87 | 379.02 |
| −7.49 | −3.50 | 379.02 |
| −8.16 | −4.06 | 379.02 |
| −8.75 | −4.54 | 379.02 |
| −9.24 | −4.94 | 379.02 |
| −9.65 | −5.27 | 379.02 |
| −9.97 | −5.52 | 379.02 |
| −10.22 | −5.69 | 379.02 |
| −10.30 | −5.73 | 379.02 |
| −10.37 | −5.75 | 379.02 |
| −10.43 | −5.77 | 379.02 |
| −10.48 | −5.78 | 379.02 |
| −10.52 | −5.77 | 379.02 |
| −10.55 | −5.76 | 379.02 |
| −10.56 | −5.75 | 379.02 |
| −10.58 | −5.74 | 379.02 |
| −10.58 | −5.74 | 379.02 |

Radial section 50

| | | |
|---|---|---|
| −10.58 | −5.70 | 385.35 |
| −10.59 | −5.70 | 385.35 |
| −10.60 | −5.69 | 385.35 |
| −10.61 | −5.67 | 385.35 |
| −10.62 | −5.64 | 385.35 |
| −10.64 | −5.60 | 385.35 |
| −10.64 | −5.55 | 385.35 |
| −10.64 | −5.48 | 385.35 |
| −10.63 | −5.41 | 385.35 |
| −10.60 | −5.32 | 385.35 |
| −10.49 | −5.03 | 385.35 |
| −10.30 | −4.65 | 385.35 |
| −10.03 | −4.18 | 385.35 |
| −9.68 | −3.62 | 385.35 |
| −9.23 | −2.97 | 385.35 |
| −8.68 | −2.25 | 385.35 |
| −8.03 | −1.46 | 385.35 |
| −7.26 | −0.62 | 385.35 |
| −6.39 | 0.26 | 385.35 |
| −5.40 | 1.16 | 385.35 |
| −4.31 | 2.06 | 385.35 |
| −3.12 | 2.94 | 385.35 |
| −1.84 | 3.79 | 385.35 |
| −0.49 | 4.59 | 385.35 |
| 0.93 | 5.33 | 385.35 |
| 2.39 | 6.01 | 385.35 |
| 3.87 | 6.61 | 385.35 |
| 5.35 | 7.14 | 385.35 |
| 6.81 | 7.61 | 385.35 |
| 8.24 | 8.02 | 385.35 |
| 9.60 | 8.38 | 385.35 |
| 10.90 | 8.70 | 385.35 |
| 12.10 | 8.98 | 385.35 |
| 13.21 | 9.23 | 385.35 |
| 14.22 | 9.44 | 385.35 |
| 15.10 | 9.64 | 385.35 |
| 15.87 | 9.80 | 385.35 |
| 16.52 | 9.95 | 385.35 |
| 17.04 | 10.08 | 385.35 |
| 17.46 | 10.17 | 385.35 |
| 17.76 | 10.25 | 385.35 |
| 17.85 | 10.27 | 385.35 |
| 17.93 | 10.27 | 385.35 |
| 17.99 | 10.25 | 385.35 |
| 18.03 | 10.23 | 385.35 |
| 18.06 | 10.19 | 385.35 |
| 18.08 | 10.17 | 385.35 |
| 18.09 | 10.15 | 385.35 |
| 18.09 | 10.14 | 385.35 |
| 18.09 | 10.13 | 385.35 |
| 18.10 | 10.12 | 385.35 |
| 18.10 | 10.11 | 385.35 |
| 18.10 | 10.09 | 385.35 |
| 18.10 | 10.06 | 385.35 |
| 18.10 | 10.02 | 385.35 |
| 18.08 | 9.97 | 385.35 |
| 18.04 | 9.92 | 385.35 |
| 17.97 | 9.88 | 385.35 |
| 17.89 | 9.85 | 385.35 |
| 17.60 | 9.76 | 385.35 |
| 17.22 | 9.63 | 385.35 |
| 16.73 | 9.46 | 385.35 |
| 16.13 | 9.24 | 385.35 |
| 15.42 | 8.97 | 385.35 |
| 14.60 | 8.65 | 385.35 |
| 13.69 | 8.29 | 385.35 |
| 12.68 | 7.87 | 385.35 |
| 11.58 | 7.40 | 385.35 |
| 10.40 | 6.89 | 385.35 |
| 9.16 | 6.34 | 385.35 |
| 7.86 | 5.75 | 385.35 |
| 6.52 | 5.12 | 385.35 |
| 5.16 | 4.45 | 385.35 |
| 3.79 | 3.75 | 385.35 |
| 2.42 | 3.04 | 385.35 |
| 1.07 | 2.30 | 385.35 |
| −0.25 | 1.55 | 385.35 |
| −1.51 | 0.79 | 385.35 |
| −2.72 | 0.02 | 385.35 |
| −3.85 | −0.74 | 385.35 |
| −4.89 | −1.48 | 385.35 |
| −5.85 | −2.20 | 385.35 |
| −6.71 | −2.87 | 385.35 |
| −7.48 | −3.49 | 385.35 |
| −8.15 | −4.05 | 385.35 |
| −8.74 | −4.53 | 385.35 |
| −9.23 | −4.93 | 385.35 |
| −9.64 | −5.25 | 385.35 |
| −9.96 | −5.50 | 385.35 |
| −10.22 | −5.66 | 385.35 |
| −10.30 | −5.70 | 385.35 |
| −10.37 | −5.73 | 385.35 |
| −10.43 | −5.74 | 385.35 |
| −10.48 | −5.74 | 385.35 |
| −10.52 | −5.73 | 385.35 |
| −10.55 | −5.72 | 385.35 |
| −10.56 | −5.71 | 385.35 |
| −10.57 | −5.71 | 385.35 |
| −10.58 | −5.70 | 385.35 |

Radial section 58

| | | |
|---|---|---|
| −10.58 | −5.71 | 390.42 |
| −10.59 | −5.71 | 390.42 |
| −10.60 | −5.70 | 390.42 |
| −10.61 | −5.68 | 390.42 |
| −10.62 | −5.65 | 390.42 |
| −10.64 | −5.61 | 390.42 |
| −10.64 | −5.56 | 390.42 |
| −10.64 | −5.49 | 390.42 |
| −10.63 | −5.42 | 390.42 |
| −10.61 | −5.33 | 390.42 |
| −10.50 | −5.03 | 390.42 |
| −10.31 | −4.65 | 390.42 |
| −10.05 | −4.18 | 390.42 |
| −9.70 | −3.62 | 390.42 |
| −9.26 | −2.96 | 390.42 |
| −8.71 | −2.24 | 390.42 |
| −8.06 | −1.44 | 390.42 |
| −7.30 | −0.59 | 390.42 |
| −6.43 | 0.29 | 390.42 |
| −5.44 | 1.19 | 390.42 |
| −4.35 | 2.09 | 390.42 |
| −3.16 | 2.98 | 390.42 |
| −1.88 | 3.83 | 390.42 |
| −0.52 | 4.64 | 390.42 |
| 0.89 | 5.39 | 390.42 |
| 2.35 | 6.07 | 390.42 |
| 3.84 | 6.67 | 390.42 |
| 5.32 | 7.21 | 390.42 |
| 6.78 | 7.68 | 390.42 |
| 8.21 | 8.09 | 390.42 |
| 9.58 | 8.45 | 390.42 |
| 10.88 | 8.77 | 390.42 |
| 12.09 | 9.05 | 390.42 |
| 13.20 | 9.30 | 390.42 |
| 14.20 | 9.52 | 390.42 |
| 15.09 | 9.71 | 390.42 |
| 15.86 | 9.88 | 390.42 |
| 16.51 | 10.02 | 390.42 |
| 17.04 | 10.15 | 390.42 |
| 17.45 | 10.24 | 390.42 |
| 17.75 | 10.32 | 390.42 |
| 17.84 | 10.34 | 390.42 |
| 17.92 | 10.34 | 390.42 |
| 17.98 | 10.32 | 390.42 |
| 18.03 | 10.29 | 390.42 |
| 18.05 | 10.26 | 390.42 |
| 18.07 | 10.24 | 390.42 |
| 18.08 | 10.22 | 390.42 |
| 18.08 | 10.21 | 390.42 |
| 18.09 | 10.20 | 390.42 |
| 18.09 | 10.19 | 390.42 |
| 18.09 | 10.18 | 390.42 |
| 18.09 | 10.16 | 390.42 |
| 18.10 | 10.13 | 390.42 |
| 18.09 | 10.09 | 390.42 |
| 18.07 | 10.04 | 390.42 |
| 18.03 | 9.99 | 390.42 |
| 17.97 | 9.95 | 390.42 |
| 17.88 | 9.92 | 390.42 |
| 17.60 | 9.82 | 390.42 |
| 17.21 | 9.69 | 390.42 |
| 16.72 | 9.52 | 390.42 |
| 16.12 | 9.30 | 390.42 |
| 15.41 | 9.03 | 390.42 |
| 14.60 | 8.71 | 390.42 |
| 13.69 | 8.33 | 390.42 |
| 12.68 | 7.91 | 390.42 |
| 11.58 | 7.44 | 390.42 |
| 10.40 | 6.92 | 390.42 |
| 9.16 | 6.36 | 390.42 |
| 7.87 | 5.76 | 390.42 |
| 6.54 | 5.12 | 390.42 |
| 5.18 | 4.44 | 390.42 |
| 3.81 | 3.74 | 390.42 |
| 2.44 | 3.02 | 390.42 |
| 1.09 | 2.27 | 390.42 |
| −0.23 | 1.52 | 390.42 |
| −1.50 | 0.76 | 390.42 |
| −2.70 | 0.00 | 390.42 |
| −3.83 | −0.76 | 390.42 |
| −4.88 | −1.51 | 390.42 |
| −5.83 | −2.22 | 390.42 |
| −6.70 | −2.89 | 390.42 |
| −7.47 | −3.51 | 390.42 |
| −8.14 | −4.07 | 390.42 |
| −8.73 | −4.55 | 390.42 |
| −9.22 | −4.95 | 390.42 |
| −9.63 | −5.28 | 390.42 |
| −9.96 | −5.52 | 390.42 |
| −10.21 | −5.68 | 390.42 |
| −10.30 | −5.72 | 390.42 |
| −10.37 | −5.74 | 390.42 |
| −10.43 | −5.76 | 390.42 |
| −10.48 | −5.75 | 390.42 |
| −10.52 | −5.75 | 390.42 |
| −10.55 | −5.74 | 390.42 |
| −10.56 | −5.72 | 390.42 |
| −10.57 | −5.72 | 390.42 |
| −10.58 | −5.71 | 390.42 |

Radial section 67

| | | |
|---|---|---|
| −10.58 | −5.77 | 395.48 |
| −10.59 | −5.76 | 395.48 |
| −10.60 | −5.75 | 395.48 |
| −10.61 | −5.73 | 395.48 |
| −10.62 | −5.71 | 395.48 |
| −10.64 | −5.67 | 395.48 |
| −10.65 | −5.61 | 395.48 |
| −10.65 | −5.55 | 395.48 |
| −10.64 | −5.47 | 395.48 |
| −10.62 | −5.38 | 395.48 |
| −10.51 | −5.08 | 395.48 |
| −10.33 | −4.70 | 395.48 |
| −10.07 | −4.22 | 395.48 |
| −9.73 | −3.65 | 395.48 |
| −9.29 | −2.99 | 395.48 |
| −8.75 | −2.25 | 395.48 |
| −8.11 | −1.45 | 395.48 |
| −7.35 | −0.59 | 395.48 |
| −6.48 | 0.30 | 395.48 |
| −5.50 | 1.21 | 395.48 |
| −4.40 | 2.12 | 395.48 |
| −3.21 | 3.01 | 395.48 |
| −1.93 | 3.87 | 395.48 |
| −0.57 | 4.69 | 395.48 |
| 0.84 | 5.45 | 395.48 |
| 2.30 | 6.15 | 395.48 |
| 3.78 | 6.77 | 395.48 |
| 5.27 | 7.32 | 395.48 |
| 6.73 | 7.81 | 395.48 |
| 8.16 | 8.23 | 395.48 |
| 9.53 | 8.60 | 395.48 |
| 10.83 | 8.93 | 395.48 |
| 12.05 | 9.21 | 395.48 |
| 13.16 | 9.46 | 395.48 |
| 14.17 | 9.68 | 395.48 |
| 15.06 | 9.87 | 395.48 |
| 15.83 | 10.05 | 395.48 |
| 16.48 | 10.19 | 395.48 |
| 17.01 | 10.32 | 395.48 |
| 17.43 | 10.42 | 395.48 |
| 17.73 | 10.50 | 395.48 |
| 17.82 | 10.52 | 395.48 |
| 17.90 | 10.52 | 395.48 |
| 17.96 | 10.50 | 395.48 |
| 18.01 | 10.47 | 395.48 |
| 18.03 | 10.44 | 395.48 |
| 18.05 | 10.42 | 395.48 |
| 18.06 | 10.40 | 395.48 |
| 18.07 | 10.38 | 395.48 |
| 18.07 | 10.38 | 395.48 |
| 18.07 | 10.37 | 395.48 |
| 18.07 | 10.35 | 395.48 |
| 18.08 | 10.33 | 395.48 |
| 18.08 | 10.30 | 395.48 |
| 18.07 | 10.26 | 395.48 |
| 18.06 | 10.22 | 395.48 |
| 18.02 | 10.17 | 395.48 |
| 17.96 | 10.12 | 395.48 |
| 17.87 | 10.09 | 395.48 |
| 17.59 | 10.00 | 395.48 |
| 17.20 | 9.86 | 395.48 |
| 16.71 | 9.68 | 395.48 |
| 16.11 | 9.46 | 395.48 |
| 15.40 | 9.18 | 395.48 |
| 14.59 | 8.86 | 395.48 |
| 13.67 | 8.47 | 395.48 |
| 12.66 | 8.04 | 395.48 |
| 11.57 | 7.56 | 395.48 |
| 10.40 | 7.03 | 395.48 |
| 9.16 | 6.45 | 395.48 |
| 7.87 | 5.83 | 395.48 |
| 6.54 | 5.17 | 395.48 |
| 5.18 | 4.48 | 395.48 |
| 3.82 | 3.76 | 395.48 |
| 2.45 | 3.02 | 395.48 |
| 1.11 | 2.26 | 395.48 |
| −0.21 | 1.50 | 395.48 |
| −1.48 | 0.73 | 395.48 |
| −2.69 | −0.03 | 395.48 |
| −3.82 | −0.80 | 395.48 |
| −4.87 | −1.54 | 395.48 |
| −5.83 | −2.26 | 395.48 |
| −6.69 | −2.94 | 395.48 |
| −7.47 | −3.56 | 395.48 |
| −8.14 | −4.12 | 395.48 |
| −8.73 | −4.60 | 395.48 |
| −9.22 | −5.01 | 395.48 |
| −9.63 | −5.34 | 395.48 |
| −9.96 | −5.58 | 395.48 |
| −10.21 | −5.74 | 395.48 |
| −10.29 | −5.78 | 395.48 |
| −10.37 | −5.80 | 395.48 |
| −10.43 | −5.81 | 395.48 |
| −10.48 | −5.81 | 395.48 |
| −10.52 | −5.80 | 395.48 |
| −10.54 | −5.79 | 395.48 |
| −10.56 | −5.78 | 395.48 |
| −10.57 | −5.77 | 395.48 |
| −10.58 | −5.77 | 395.48 |

Radial section 75

| | | |
|---|---|---|
| −10.57 | −5.88 | 400.55 |
| −10.58 | −5.87 | 400.55 |
| −10.59 | −5.86 | 400.55 |
| −10.60 | −5.84 | 400.55 |
| −10.62 | −5.82 | 400.55 |
| −10.63 | −5.78 | 400.55 |
| −10.64 | −5.73 | 400.55 |
| −10.65 | −5.66 | 400.55 |
| −10.64 | −5.58 | 400.55 |
| −10.62 | −5.49 | 400.55 |
| −10.53 | −5.19 | 400.55 |
| −10.36 | −4.79 | 400.55 |
| −10.11 | −4.31 | 400.55 |
| −9.78 | −3.72 | 400.55 |
| −9.35 | −3.05 | 400.55 |
| −8.82 | −2.30 | 400.55 |
| −8.18 | −1.48 | 400.55 |
| −7.42 | −0.61 | 400.55 |
| −6.56 | 0.29 | 400.55 |
| −5.57 | 1.22 | 400.55 |
| −4.48 | 2.14 | 400.55 |
| −3.29 | 3.05 | 400.55 |
| −2.01 | 3.93 | 400.55 |
| −0.65 | 4.78 | 400.55 |
| 0.76 | 5.56 | 400.55 |
| 2.22 | 6.29 | 400.55 |
| 3.70 | 6.94 | 400.55 |
| 5.18 | 7.52 | 400.55 |
| 6.65 | 8.03 | 400.55 |
| 8.08 | 8.48 | 400.55 |
| 9.46 | 8.87 | 400.55 |
| 10.76 | 9.21 | 400.55 |
| 11.98 | 9.51 | 400.55 |
| 13.10 | 9.78 | 400.55 |
| 14.11 | 10.01 | 400.55 |
| 15.01 | 10.21 | 400.55 |
| 15.79 | 10.39 | 400.55 |
| 16.44 | 10.54 | 400.55 |
| 16.97 | 10.67 | 400.55 |
| 17.39 | 10.78 | 400.55 |
| 17.69 | 10.86 | 400.55 |
| 17.78 | 10.88 | 400.55 |
| 17.86 | 10.88 | 400.55 |
| 17.93 | 10.86 | 400.55 |
| 17.97 | 10.83 | 400.55 |
| 18.00 | 10.80 | 400.55 |
| 18.02 | 10.77 | 400.55 |
| 18.03 | 10.75 | 400.55 |
| 18.03 | 10.74 | 400.55 |
| 18.03 | 10.73 | 400.55 |
| 18.04 | 10.72 | 400.55 |
| 18.04 | 10.71 | 400.55 |
| 18.04 | 10.69 | 400.55 |
| 18.04 | 10.66 | 400.55 |
| 18.04 | 10.62 | 400.55 |
| 18.02 | 10.57 | 400.55 |
| 17.98 | 10.52 | 400.55 |
| 17.92 | 10.48 | 400.55 |
| 17.83 | 10.45 | 400.55 |
| 17.55 | 10.35 | 400.55 |
| 17.16 | 10.21 | 400.55 |
| 16.67 | 10.02 | 400.55 |
| 16.07 | 9.79 | 400.55 |
| 15.36 | 9.50 | 400.55 |
| 14.55 | 9.16 | 400.55 |
| 13.63 | 8.77 | 400.55 |
| 12.62 | 8.32 | 400.55 |
| 11.53 | 7.81 | 400.55 |
| 10.36 | 7.26 | 400.55 |
| 9.13 | 6.65 | 400.55 |
| 7.84 | 6.00 | 400.55 |
| 6.52 | 5.31 | 400.55 |
| 5.18 | 4.59 | 400.55 |
| 3.82 | 3.83 | 400.55 |
| 2.46 | 3.07 | 400.55 |
| 1.11 | 2.29 | 400.55 |
| −0.20 | 1.51 | 400.55 |
| −1.47 | 0.73 | 400.55 |
| −2.68 | −0.05 | 400.55 |
| −3.82 | −0.82 | 400.55 |
| −4.87 | −1.58 | 400.55 |
| −5.83 | −2.30 | 400.55 |
| −6.70 | −2.98 | 400.55 |
| −7.47 | −3.62 | 400.55 |
| −8.14 | −4.19 | 400.55 |
| −8.73 | −4.68 | 400.55 |
| −9.22 | −5.09 | 400.55 |
| −9.62 | −5.43 | 400.55 |
| −9.95 | −5.68 | 400.55 |
| −10.20 | −5.85 | 400.55 |
| −10.28 | −5.88 | 400.55 |
| −10.36 | −5.91 | 400.55 |
| −10.42 | −5.92 | 400.55 |
| −10.47 | −5.92 | 400.55 |
| −10.51 | −5.91 | 400.55 |
| −10.54 | −5.90 | 400.55 |
| −10.55 | −5.89 | 400.55 |
| −10.56 | −5.88 | 400.55 |
| −10.57 | −5.88 | 400.55 |

Radial section 84

| | | |
|---|---|---|
| −10.55 | −6.07 | 405.61 |
| −10.56 | −6.06 | 405.61 |
| −10.57 | −6.05 | 405.61 |
| −10.58 | −6.04 | 405.61 |
| −10.60 | −6.01 | 405.61 |
| −10.62 | −5.97 | 405.61 |
| −10.63 | −5.92 | 405.61 |
| −10.64 | −5.85 | 405.61 |
| −10.64 | −5.77 | 405.61 |
| −10.62 | −5.68 | 405.61 |
| −10.54 | −5.37 | 405.61 |
| −10.38 | −4.96 | 405.61 |
| −10.15 | −4.46 | 405.61 |
| −9.84 | −3.86 | 405.61 |
| −9.43 | −3.16 | 405.61 |
| −8.92 | −2.38 | 405.61 |
| −8.29 | −1.54 | 405.61 |
| −7.55 | −0.63 | 405.61 |
| −6.69 | 0.31 | 405.61 |
| −5.72 | 1.27 | 405.61 |
| −4.64 | 2.23 | 405.61 |
| −3.45 | 3.19 | 405.61 |
| −2.18 | 4.11 | 405.61 |
| −0.83 | 5.00 | 405.61 |
| 0.58 | 5.85 | 405.61 |
| 2.03 | 6.63 | 405.61 |
| 3.51 | 7.33 | 405.61 |
| 5.00 | 7.97 | 405.61 |
| 6.47 | 8.53 | 405.61 |
| 7.91 | 9.03 | 405.61 |
| 9.29 | 9.46 | 405.61 |
| 10.61 | 9.84 | 405.61 |
| 11.84 | 10.17 | 405.61 |
| 12.97 | 10.46 | 405.61 |
| 13.99 | 10.71 | 405.61 |
| 14.90 | 10.92 | 405.61 |
| 15.68 | 11.11 | 405.61 |
| 16.34 | 11.28 | 405.61 |
| 16.88 | 11.42 | 405.61 |
| 17.30 | 11.53 | 405.61 |
| 17.60 | 11.62 | 405.61 |
| 17.70 | 11.64 | 405.61 |
| 17.78 | 11.65 | 405.61 |
| 17.84 | 11.63 | 405.61 |
| 17.89 | 11.60 | 405.61 |
| 17.92 | 11.57 | 405.61 |
| 17.94 | 11.55 | 405.61 |
| 17.95 | 11.53 | 405.61 |
| 17.95 | 11.51 | 405.61 |
| 17.95 | 11.51 | 405.61 |
| 17.96 | 11.50 | 405.61 |
| 17.96 | 11.48 | 405.61 |
| 17.96 | 11.46 | 405.61 |
| 17.97 | 11.43 | 405.61 |
| 17.96 | 11.39 | 405.61 |
| 17.94 | 11.34 | 405.61 |
| 17.91 | 11.29 | 405.61 |
| 17.84 | 11.25 | 405.61 |
| 17.76 | 11.22 | 405.61 |
| 17.47 | 11.11 | 405.61 |
| 17.08 | 10.96 | 405.61 |
| 16.59 | 10.76 | 405.61 |
| 15.99 | 10.51 | 405.61 |
| 15.28 | 10.21 | 405.61 |
| 14.46 | 9.84 | 405.61 |
| 13.54 | 9.42 | 405.61 |
| 12.53 | 8.94 | 405.61 |
| 11.44 | 8.40 | 405.61 |
| 10.28 | 7.80 | 405.61 |
| 9.05 | 7.15 | 405.61 |
| 7.77 | 6.45 | 405.61 |
| 6.46 | 5.70 | 405.61 |
| 5.12 | 4.92 | 405.61 |
| 3.77 | 4.11 | 405.61 |
| 2.42 | 3.29 | 405.61 |
| 1.08 | 2.47 | 405.61 |
| −0.23 | 1.65 | 405.61 |
| −1.50 | 0.83 | 405.61 |
| −2.71 | 0.01 | 405.61 |
| −3.84 | −0.79 | 405.61 |
| −4.89 | −1.58 | 405.61 |
| −5.85 | −2.33 | 405.61 |
| −6.72 | −3.04 | 405.61 |
| −7.48 | −3.69 | 405.61 |
| −8.15 | −4.29 | 405.61 |
| −8.72 | −4.81 | 405.61 |
| −9.21 | −5.24 | 405.61 |
| −9.61 | −5.59 | 405.61 |
| −9.93 | −5.86 | 405.61 |
| −10.18 | −6.03 | 405.61 |
| −10.26 | −6.07 | 405.61 |
| −10.33 | −6.10 | 405.61 |
| −10.40 | −6.11 | 405.61 |
| −10.45 | −6.11 | 405.61 |
| −10.49 | −6.10 | 405.61 |
| −10.52 | −6.09 | 405.61 |
| −10.54 | −6.08 | 405.61 |
| −10.55 | −6.07 | 405.61 |
| −10.55 | −6.07 | 405.61 |

Radial section 90

| | | |
|---|---|---|
| −10.52 | −6.38 | 409.41 |
| −10.53 | −6.38 | 409.41 |
| −10.54 | −6.37 | 409.41 |
| −10.55 | −6.35 | 409.41 |
| −10.57 | −6.32 | 409.41 |
| −10.59 | −6.28 | 409.41 |
| −10.60 | −6.23 | 409.41 |
| −10.61 | −6.16 | 409.41 |
| −10.61 | −6.08 | 409.41 |
| −10.60 | −5.98 | 409.41 |
| −10.52 | −5.67 | 409.41 |
| −10.37 | −5.25 | 409.41 |
| −10.16 | −4.73 | 409.41 |
| −9.86 | −4.10 | 409.41 |
| −9.48 | −3.37 | 409.41 |
| −8.99 | −2.56 | 409.41 |
| −8.39 | −1.66 | 409.41 |
| −7.68 | −0.71 | 409.41 |
| −6.85 | 0.29 | 409.41 |
| −5.90 | 1.31 | 409.41 |
| −4.84 | 2.34 | 409.41 |
| −3.67 | 3.37 | 409.41 |
| −2.42 | 4.37 | 409.41 |
| −1.08 | 5.33 | 409.41 |
| 0.32 | 6.25 | 409.41 |
| 1.76 | 7.11 | 409.41 |
| 3.24 | 7.90 | 409.41 |
| 4.73 | 8.60 | 409.41 |
| 6.21 | 9.23 | 409.41 |
| 7.66 | 9.79 | 409.41 |
| 9.05 | 10.27 | 409.41 |
| 10.38 | 10.70 | 409.41 |
| 11.63 | 11.07 | 409.41 |
| 12.77 | 11.39 | 409.41 |
| 13.81 | 11.67 | 409.41 |
| 14.73 | 11.91 | 409.41 |
| 15.53 | 12.12 | 409.41 |
| 16.20 | 12.30 | 409.41 |
| 16.74 | 12.45 | 409.41 |
| 17.17 | 12.57 | 409.41 |
| 17.48 | 12.66 | 409.41 |
| 17.57 | 12.69 | 409.41 |
| 17.66 | 12.70 | 409.41 |
| 17.72 | 12.69 | 409.41 |
| 17.77 | 12.66 | 409.41 |
| 17.80 | 12.63 | 409.41 |
| 17.82 | 12.61 | 409.41 |
| 17.84 | 12.59 | 409.41 |
| 17.84 | 12.57 | 409.41 |
| 17.85 | 12.56 | 409.41 |
| 17.85 | 12.56 | 409.41 |
| 17.85 | 12.54 | 409.41 |
| 17.86 | 12.52 | 409.41 |
| 17.86 | 12.49 | 409.41 |
| 17.86 | 12.45 | 409.41 |
| 17.84 | 12.40 | 409.41 |
| 17.80 | 12.35 | 409.41 |
| 17.74 | 12.30 | 409.41 |
| 17.66 | 12.26 | 409.41 |
| 17.37 | 12.14 | 409.41 |
| 16.98 | 11.97 | 409.41 |
| 16.48 | 11.76 | 409.41 |
| 15.88 | 11.49 | 409.41 |
| 15.16 | 11.15 | 409.41 |
| 14.34 | 10.76 | 409.41 |
| 13.42 | 10.30 | 409.41 |
| 12.40 | 9.78 | 409.41 |
| 11.31 | 9.20 | 409.41 |
| 10.14 | 8.56 | 409.41 |
| 8.91 | 7.86 | 409.41 |
| 7.63 | 7.10 | 409.41 |
| 6.32 | 6.29 | 409.41 |
| 4.99 | 5.44 | 409.41 |
| 3.65 | 4.56 | 409.41 |
| 2.31 | 3.67 | 409.41 |
| 0.98 | 2.78 | 409.41 |
| −0.33 | 1.89 | 409.41 |
| −1.59 | 1.01 | 409.41 |
| −2.79 | 0.14 | 409.41 |
| −3.92 | −0.72 | 409.41 |
| −4.96 | −1.55 | 409.41 |
| −5.91 | −2.35 | 409.41 |
| −6.76 | −3.10 | 409.41 |
| −7.52 | −3.80 | 409.41 |
| −8.17 | −4.44 | 409.41 |
| −8.73 | −4.99 | 409.41 |
| −9.21 | −5.46 | 409.41 |
| −9.59 | −5.84 | 409.41 |
| −9.90 | −6.13 | 409.41 |
| −10.15 | −6.32 | 409.41 |
| −10.23 | −6.37 | 409.41 |
| −10.30 | −6.40 | 409.41 |
| −10.36 | −6.42 | 409.41 |
| −10.41 | −6.42 | 409.41 |
| −10.45 | −6.42 | 409.41 |
| −10.48 | −6.41 | 409.41 |
| −10.50 | −6.40 | 409.41 |
| −10.51 | −6.39 | 409.41 |
| −10.52 | −6.38 | 409.41 |

Radial section 92

| | | |
|---|---|---|
| −10.47 | −6.78 | 412.00 |
| −10.48 | −6.78 | 412.00 |
| −10.49 | −6.77 | 412.00 |
| −10.51 | −6.75 | 412.00 |
| −10.52 | −6.72 | 412.00 |
| −10.54 | −6.68 | 412.00 |
| −10.56 | −6.63 | 412.00 |
| −10.57 | −6.56 | 412.00 |
| −10.57 | −6.47 | 412.00 |
| −10.55 | −6.37 | 412.00 |
| −10.47 | −6.05 | 412.00 |
| −10.32 | −5.63 | 412.00 |
| −10.11 | −5.09 | 412.00 |
| −9.82 | −4.44 | 412.00 |
| −9.45 | −3.68 | 412.00 |
| −8.98 | −2.83 | 412.00 |
| −8.41 | −1.90 | 412.00 |
| −7.73 | −0.89 | 412.00 |
| −6.93 | 0.16 | 412.00 |
| −6.01 | 1.25 | 412.00 |
| −4.98 | 2.36 | 412.00 |
| −3.85 | 3.47 | 412.00 |
| −2.62 | 4.55 | 412.00 |
| −1.30 | 5.60 | 412.00 |
| 0.09 | 6.61 | 412.00 |
| 1.53 | 7.54 | 412.00 |
| 3.00 | 8.41 | 412.00 |
| 4.49 | 9.19 | 412.00 |
| 5.97 | 9.90 | 412.00 |
| 7.42 | 10.53 | 412.00 |
| 8.83 | 11.09 | 412.00 |
| 10.16 | 11.58 | 412.00 |
| 11.42 | 12.02 | 412.00 |
| 12.57 | 12.39 | 412.00 |
| 13.62 | 12.71 | 412.00 |
| 14.55 | 12.99 | 412.00 |
| 15.36 | 13.22 | 412.00 |
| 16.04 | 13.42 | 412.00 |
| 16.60 | 13.58 | 412.00 |
| 17.03 | 13.71 | 412.00 |
| 17.35 | 13.81 | 412.00 |
| 17.44 | 13.85 | 412.00 |
| 17.52 | 13.87 | 412.00 |
| 17.59 | 13.87 | 412.00 |
| 17.64 | 13.86 | 412.00 |
| 17.68 | 13.83 | 412.00 |
| 17.70 | 13.81 | 412.00 |
| 17.72 | 13.79 | 412.00 |
| 17.72 | 13.78 | 412.00 |
| 17.73 | 13.77 | 412.00 |
| 17.73 | 13.76 | 412.00 |
| 17.74 | 13.75 | 412.00 |
| 17.75 | 13.73 | 412.00 |
| 17.75 | 13.70 | 412.00 |
| 17.75 | 13.66 | 412.00 |
| 17.73 | 13.60 | 412.00 |
| 17.69 | 13.55 | 412.00 |
| 17.63 | 13.51 | 412.00 |
| 17.54 | 13.47 | 412.00 |
| 17.25 | 13.33 | 412.00 |
| 16.86 | 13.14 | 412.00 |
| 16.36 | 12.90 | 412.00 |
| 15.76 | 12.59 | 412.00 |
| 15.04 | 12.22 | 412.00 |
| 14.22 | 11.78 | 412.00 |
| 13.30 | 11.28 | 412.00 |
| 12.28 | 10.71 | 412.00 |
| 11.18 | 10.07 | 412.00 |
| 10.02 | 9.36 | 412.00 |
| 8.79 | 8.59 | 412.00 |
| 7.52 | 7.76 | 412.00 |
| 6.22 | 6.87 | 412.00 |
| 4.90 | 5.94 | 412.00 |
| 3.57 | 4.99 | 412.00 |
| 2.24 | 4.02 | 412.00 |
| 0.91 | 3.05 | 412.00 |
| −0.38 | 2.09 | 412.00 |
| −1.64 | 1.14 | 412.00 |
| −2.83 | 0.20 | 412.00 |
| −3.95 | −0.71 | 412.00 |
| −4.99 | −1.60 | 412.00 |
| −5.94 | −2.45 | 412.00 |
| −6.78 | −3.25 | 412.00 |
| −7.53 | −3.99 | 412.00 |
| −8.17 | −4.66 | 412.00 |
| −8.73 | −5.25 | 412.00 |
| −9.19 | −5.75 | 412.00 |
| −9.57 | −6.15 | 412.00 |
| −9.87 | −6.47 | 412.00 |
| −10.10 | −6.68 | 412.00 |
| −10.18 | −6.74 | 412.00 |
| −10.25 | −6.78 | 412.00 |
| −10.31 | −6.81 | 412.00 |
| −10.36 | −6.81 | 412.00 |
| −10.40 | −6.81 | 412.00 |
| −10.43 | −6.80 | 412.00 |
| −10.45 | −6.80 | 412.00 |
| −10.47 | −6.79 | 412.00 |
| −10.47 | −6.78 | 412.00 |

Radial section 93

| | | |
|---|---|---|
| −10.45 | −7.03 | 413.20 |
| −10.46 | −7.03 | 413.20 |
| −10.47 | −7.02 | 413.20 |
| −10.48 | −7.00 | 413.20 |
| −10.50 | −6.97 | 413.20 |
| −10.52 | −6.93 | 413.20 |
| −10.53 | −6.88 | 413.20 |
| −10.54 | −6.81 | 413.20 |
| −10.54 | −6.72 | 413.20 |
| −10.53 | −6.62 | 413.20 |
| −10.44 | −6.30 | 413.20 |
| −10.30 | −5.86 | 413.20 |
| −10.09 | −5.32 | 413.20 |
| −9.81 | −4.66 | 413.20 |
| −9.44 | −3.89 | 413.20 |
| −8.98 | −3.02 | 413.20 |
| −8.42 | −2.06 | 413.20 |
| −7.75 | −1.03 | 413.20 |
| −6.97 | 0.06 | 413.20 |
| −6.08 | 1.19 | 413.20 |
| −5.07 | 2.34 | 413.20 |
| −3.96 | 3.50 | 413.20 |
| −2.74 | 4.63 | 413.20 |
| −1.44 | 5.73 | 413.20 |
| −0.06 | 6.78 | 413.20 |
| 1.37 | 7.76 | 413.20 |
| 2.85 | 8.66 | 413.20 |
| 4.34 | 9.48 | 413.20 |
| 5.82 | 10.23 | 413.20 |
| 7.28 | 10.89 | 413.20 |
| 8.70 | 11.48 | 413.20 |
| 10.04 | 11.99 | 413.20 |
| 11.31 | 12.44 | 413.20 |
| 12.47 | 12.83 | 413.20 |
| 13.53 | 13.17 | 413.20 |
| 14.47 | 13.45 | 413.20 |
| 15.28 | 13.70 | 413.20 |
| 15.97 | 13.91 | 413.20 |
| 16.53 | 14.07 | 413.20 |
| 16.97 | 14.20 | 413.20 |
| 17.29 | 14.30 | 413.20 |
| 17.39 | 14.33 | 413.20 |
| 17.47 | 14.34 | 413.20 |
| 17.54 | 14.34 | 413.20 |
| 17.60 | 14.32 | 413.20 |
| 17.63 | 14.29 | 413.20 |
| 17.65 | 14.26 | 413.20 |
| 17.67 | 14.24 | 413.20 |
| 17.67 | 14.23 | 413.20 |
| 17.68 | 14.22 | 413.20 |
| 17.68 | 14.21 | 413.20 |
| 17.69 | 14.20 | 413.20 |
| 17.69 | 14.18 | 413.20 |
| 17.70 | 14.15 | 413.20 |
| 17.69 | 14.10 | 413.20 |
| 17.68 | 14.05 | 413.20 |
| 17.64 | 14.00 | 413.20 |
| 17.57 | 13.95 | 413.20 |
| 17.49 | 13.91 | 413.20 |
| 17.20 | 13.76 | 413.20 |
| 16.81 | 13.57 | 413.20 |
| 16.31 | 13.31 | 413.20 |
| 15.70 | 13.00 | 413.20 |
| 14.98 | 12.62 | 413.20 |
| 14.15 | 12.17 | 413.20 |
| 13.22 | 11.65 | 413.20 |
| 12.20 | 11.06 | 413.20 |
| 11.10 | 10.41 | 413.20 |
| 9.92 | 9.68 | 413.20 |
| 8.69 | 8.89 | 413.20 |
| 7.42 | 8.03 | 413.20 |
| 6.12 | 7.12 | 413.20 |
| 4.80 | 6.16 | 413.20 |
| 3.47 | 5.17 | 413.20 |
| 2.14 | 4.17 | 413.20 |
| 0.83 | 3.17 | 413.20 |
| −0.46 | 2.17 | 413.20 |
| −1.71 | 1.18 | 413.20 |
| −2.89 | 0.20 | 413.20 |
| −4.00 | −0.75 | 413.20 |
| −5.03 | −1.67 | 413.20 |
| −5.97 | −2.55 | 413.20 |
| −6.81 | −3.37 | 413.20 |
| −7.55 | −4.14 | 413.20 |
| −8.19 | −4.83 | 413.20 |
| −8.73 | −5.43 | 413.20 |
| −9.19 | −5.94 | 413.20 |
| −9.56 | −6.36 | 413.20 |
| −9.85 | −6.69 | 413.20 |
| −10.08 | −6.92 | 413.20 |
| −10.15 | −6.98 | 413.20 |
| −10.22 | −7.03 | 413.20 |
| −10.28 | −7.05 | 413.20 |
| −10.33 | −7.06 | 413.20 |
| −10.38 | −7.06 | 413.20 |
| −10.41 | −7.06 | 413.20 |
| −10.43 | −7.05 | 413.20 |
| −10.44 | −7.04 | 413.20 |
| −10.45 | −7.03 | 413.20 |

Radial section 95

| | | |
|---|---|---|
| −10.35 | −7.69 | 415.48 |
| −10.36 | −7.69 | 415.48 |
| −10.37 | −7.68 | 415.48 |
| −10.39 | −7.66 | 415.48 |
| −10.41 | −7.63 | 415.48 |
| −10.43 | −7.59 | 415.48 |
| −10.45 | −7.53 | 415.48 |
| −10.45 | −7.46 | 415.48 |
| −10.45 | −7.37 | 415.48 |
| −10.44 | −7.27 | 415.48 |
| −10.37 | −6.93 | 415.48 |
| −10.23 | −6.48 | 415.48 |
| −10.02 | −5.92 | 415.48 |
| −9.75 | −5.23 | 415.48 |
| −9.40 | −4.43 | 415.48 |
| −8.96 | −3.52 | 415.48 |
| −8.43 | −2.51 | 415.48 |
| −7.80 | −1.41 | 415.48 |
| −7.07 | −0.24 | 415.48 |
| −6.22 | 0.98 | 415.48 |
| −5.27 | 2.23 | 415.48 |
| −4.20 | 3.48 | 415.48 |
| −3.02 | 4.72 | 415.48 |
| −1.75 | 5.93 | 415.48 |
| −0.39 | 7.08 | 415.48 |
| 1.04 | 8.15 | 415.48 |
| 2.52 | 9.14 | 415.48 |
| 4.03 | 10.04 | 415.48 |
| 5.53 | 10.84 | 415.48 |
| 7.02 | 11.55 | 415.48 |
| 8.47 | 12.17 | 415.48 |
| 9.85 | 12.71 | 415.48 |
| 11.15 | 13.18 | 415.48 |
| 12.35 | 13.58 | 415.48 |
| 13.44 | 13.92 | 415.48 |
| 14.41 | 14.21 | 415.48 |
| 15.25 | 14.45 | 415.48 |
| 15.96 | 14.65 | 415.48 |
| 16.54 | 14.81 | 415.48 |
| 17.00 | 14.92 | 415.48 |
| 17.34 | 14.95 | 415.48 |
| 17.44 | 14.92 | 415.48 |
| 17.52 | 14.87 | 415.48 |
| 17.57 | 14.82 | 415.48 |
| 17.60 | 14.77 | 415.48 |
| 17.62 | 14.73 | 415.48 |
| 17.63 | 14.70 | 415.48 |
| 17.63 | 14.67 | 415.48 |
| 17.63 | 14.66 | 415.48 |
| 17.64 | 14.65 | 415.48 |
| 17.64 | 14.64 | 415.48 |
| 17.64 | 14.63 | 415.48 |
| 17.64 | 14.60 | 415.48 |
| 17.63 | 14.57 | 415.48 |
| 17.63 | 14.53 | 415.48 |
| 17.61 | 14.47 | 415.48 |
| 17.58 | 14.41 | 415.48 |
| 17.53 | 14.35 | 415.48 |
| 17.46 | 14.28 | 415.48 |
| 17.17 | 14.13 | 415.48 |
| 16.77 | 13.94 | 415.48 |
| 16.25 | 13.69 | 415.48 |
| 15.63 | 13.38 | 415.48 |
| 14.89 | 13.00 | 415.48 |
| 14.04 | 12.56 | 415.48 |
| 13.09 | 12.04 | 415.48 |
| 12.04 | 11.46 | 415.48 |
| 10.92 | 10.79 | 415.48 |
| 9.72 | 10.06 | 415.48 |
| 8.47 | 9.25 | 415.48 |
| 7.17 | 8.38 | 415.48 |
| 5.85 | 7.44 | 415.48 |
| 4.52 | 6.45 | 415.48 |
| 3.18 | 5.42 | 415.48 |
| 1.86 | 4.37 | 415.48 |
| 0.56 | 3.30 | 415.48 |
| −0.71 | 2.22 | 415.48 |
| −1.93 | 1.15 | 415.48 |
| −3.08 | 0.10 | 415.48 |
| −4.16 | −0.93 | 415.48 |
| −5.16 | −1.92 | 415.48 |
| −6.07 | −2.85 | 415.48 |
| −6.88 | −3.73 | 415.48 |
| −7.60 | −4.54 | 415.48 |
| −8.21 | −5.28 | 415.48 |
| −8.73 | −5.93 | 415.48 |
| −9.16 | −6.48 | 415.48 |
| −9.51 | −6.93 | 415.48 |
| −9.78 | −7.28 | 415.48 |
| −9.99 | −7.53 | 415.48 |
| −10.06 | −7.60 | 415.48 |
| −10.12 | −7.66 | 415.48 |
| −10.18 | −7.69 | 415.48 |
| −10.23 | −7.71 | 415.48 |
| −10.28 | −7.72 | 415.48 |
| −10.31 | −7.71 | 415.48 |
| −10.33 | −7.70 | 415.48 |
| −10.34 | −7.70 | 415.48 |
| −10.35 | −7.69 | 415.48 |

Radial section 97

| | | |
|---|---|---|
| −10.30 | −8.01 | 417.00 |
| −10.31 | −8.01 | 417.00 |
| −10.32 | −8.00 | 417.00 |
| −10.34 | −7.98 | 417.00 |
| −10.36 | −7.95 | 417.00 |
| −10.38 | −7.91 | 417.00 |
| −10.40 | −7.85 | 417.00 |
| −10.41 | −7.78 | 417.00 |
| −10.41 | −7.69 | 417.00 |
| −10.39 | −7.59 | 417.00 |
| −10.33 | −7.24 | 417.00 |
| −10.21 | −6.78 | 417.00 |
| −10.00 | −6.21 | 417.00 |
| −9.72 | −5.51 | 417.00 |
| −9.38 | −4.69 | 417.00 |
| −8.95 | −3.76 | 417.00 |
| −8.44 | −2.72 | 417.00 |
| −7.83 | −1.59 | 417.00 |
| −7.11 | −0.38 | 417.00 |
| −6.29 | 0.88 | 417.00 |
| −5.36 | 2.17 | 417.00 |
| −4.31 | 3.48 | 417.00 |
| −3.15 | 4.77 | 417.00 |
| −1.89 | 6.02 | 417.00 |
| −0.54 | 7.22 | 417.00 |
| 0.89 | 8.34 | 417.00 |
| 2.37 | 9.37 | 417.00 |
| 3.89 | 10.30 | 417.00 |
| 5.41 | 11.13 | 417.00 |
| 6.92 | 11.85 | 417.00 |
| 8.39 | 12.48 | 417.00 |
| 9.80 | 13.02 | 417.00 |
| 11.12 | 13.48 | 417.00 |
| 12.34 | 13.88 | 417.00 |
| 13.45 | 14.22 | 417.00 |
| 14.43 | 14.50 | 417.00 |
| 15.29 | 14.75 | 417.00 |
| 16.01 | 14.95 | 417.00 |
| 16.60 | 15.10 | 417.00 |
| 17.07 | 15.19 | 417.00 |
| 17.42 | 15.14 | 417.00 |
| 17.50 | 15.07 | 417.00 |
| 17.55 | 15.00 | 417.00 |
| 17.58 | 14.94 | 417.00 |
| 17.60 | 14.88 | 417.00 |
| 17.61 | 14.83 | 417.00 |
| 17.61 | 14.80 | 417.00 |
| 17.61 | 14.77 | 417.00 |
| 17.61 | 14.76 | 417.00 |
| 17.61 | 14.75 | 417.00 |
| 17.61 | 14.74 | 417.00 |
| 17.61 | 14.72 | 417.00 |
| 17.60 | 14.70 | 417.00 |
| 17.60 | 14.67 | 417.00 |
| 17.59 | 14.63 | 417.00 |
| 17.57 | 14.57 | 417.00 |
| 17.54 | 14.51 | 417.00 |
| 17.50 | 14.44 | 417.00 |
| 17.44 | 14.36 | 417.00 |
| 17.15 | 14.19 | 417.00 |
| 16.74 | 14.01 | 417.00 |
| 16.22 | 13.77 | 417.00 |
| 15.59 | 13.46 | 417.00 |
| 14.84 | 13.09 | 417.00 |
| 13.98 | 12.66 | 417.00 |
| 13.01 | 12.15 | 417.00 |
| 11.96 | 11.57 | 417.00 |
| 10.81 | 10.91 | 417.00 |
| 9.60 | 10.18 | 417.00 |
| 8.33 | 9.38 | 417.00 |
| 7.03 | 8.50 | 417.00 |
| 5.69 | 7.56 | 417.00 |
| 4.35 | 6.56 | 417.00 |
| 3.01 | 5.52 | 417.00 |
| 1.69 | 4.44 | 417.00 |
| 0.40 | 3.34 | 417.00 |
| −0.85 | 2.23 | 417.00 |
| −2.05 | 1.13 | 417.00 |
| −3.19 | 0.04 | 417.00 |
| −4.25 | −1.02 | 417.00 |
| −5.23 | −2.04 | 417.00 |
| −6.13 | −3.01 | 417.00 |
| −6.93 | −3.92 | 417.00 |
| −7.63 | −4.75 | 417.00 |
| −8.22 | −5.51 | 417.00 |
| −8.73 | −6.17 | 417.00 |
| −9.14 | −6.74 | 417.00 |
| −9.48 | −7.21 | 417.00 |
| −9.74 | −7.57 | 417.00 |
| −9.95 | −7.83 | 417.00 |
| −10.01 | −7.90 | 417.00 |
| −10.07 | −7.96 | 417.00 |
| −10.13 | −8.00 | 417.00 |
| −10.18 | −8.03 | 417.00 |
| −10.22 | −8.03 | 417.00 |
| −10.26 | −8.03 | 417.00 |
| −10.28 | −8.02 | 417.00 |
| −10.29 | −8.02 | 417.00 |
| −10.30 | −8.01 | 417.00 |

Radial section 98

| | | |
|---|---|---|
| −10.30 | −8.01 | 420.80 |
| −10.31 | −8.01 | 420.80 |
| −10.32 | −8.00 | 420.80 |
| −10.34 | −7.98 | 420.80 |
| −10.36 | −7.95 | 420.80 |
| −10.38 | −7.91 | 420.80 |
| −10.40 | −7.85 | 420.80 |
| −10.41 | −7.78 | 420.80 |
| −10.41 | −7.69 | 420.80 |
| −10.39 | −7.59 | 420.80 |
| −10.33 | −7.24 | 420.80 |
| −10.21 | −6.78 | 420.80 |
| −10.00 | −6.21 | 420.80 |
| −9.72 | −5.51 | 420.80 |
| −9.38 | −4.69 | 420.80 |
| −8.95 | −3.76 | 420.80 |
| −8.44 | −2.72 | 420.80 |
| −7.83 | −1.59 | 420.80 |
| −7.11 | −0.38 | 420.80 |
| −6.29 | 0.88 | 420.80 |
| −5.36 | 2.17 | 420.80 |
| −4.31 | 3.48 | 420.80 |
| −3.15 | 4.77 | 420.80 |
| −1.89 | 6.02 | 420.80 |
| −0.54 | 7.22 | 420.80 |
| 0.89 | 8.34 | 420.80 |
| 2.37 | 9.37 | 420.80 |
| 3.89 | 10.30 | 420.80 |
| 5.41 | 11.13 | 420.80 |
| 6.92 | 11.85 | 420.80 |
| 8.39 | 12.48 | 420.80 |
| 9.79 | 13.02 | 420.80 |
| 11.12 | 13.48 | 420.80 |
| 12.34 | 13.88 | 420.80 |
| 13.45 | 14.22 | 420.80 |
| 14.43 | 14.50 | 420.80 |
| 15.28 | 14.75 | 420.80 |
| 16.01 | 14.95 | 420.80 |
| 16.60 | 15.10 | 420.80 |
| 17.07 | 15.19 | 420.80 |
| 17.41 | 15.14 | 420.80 |
| 17.50 | 15.07 | 420.80 |
| 17.55 | 15.00 | 420.80 |
| 17.58 | 14.94 | 420.80 |
| 17.60 | 14.88 | 420.80 |
| 17.61 | 14.83 | 420.80 |
| 17.61 | 14.80 | 420.80 |
| 17.61 | 14.78 | 420.80 |
| 17.61 | 14.76 | 420.80 |
| 17.61 | 14.75 | 420.80 |
| 17.61 | 14.74 | 420.80 |
| 17.61 | 14.73 | 420.80 |
| 17.60 | 14.70 | 420.80 |
| 17.60 | 14.67 | 420.80 |
| 17.59 | 14.63 | 420.80 |
| 17.57 | 14.58 | 420.80 |
| 17.54 | 14.51 | 420.80 |
| 17.50 | 14.44 | 420.80 |
| 17.44 | 14.37 | 420.80 |
| 17.15 | 14.20 | 420.80 |
| 16.74 | 14.01 | 420.80 |
| 16.22 | 13.77 | 420.80 |
| 15.59 | 13.46 | 420.80 |
| 14.84 | 13.09 | 420.80 |
| 13.98 | 12.66 | 420.80 |
| 13.01 | 12.15 | 420.80 |
| 11.96 | 11.57 | 420.80 |
| 10.81 | 10.91 | 420.80 |
| 9.60 | 10.18 | 420.80 |
| 8.33 | 9.38 | 420.80 |
| 7.03 | 8.50 | 420.80 |
| 5.69 | 7.56 | 420.80 |
| 4.35 | 6.57 | 420.80 |
| 3.01 | 5.52 | 420.80 |
| 1.69 | 4.44 | 420.80 |
| 0.40 | 3.34 | 420.80 |
| −0.85 | 2.23 | 420.80 |
| −2.05 | 1.13 | 420.80 |
| −3.19 | 0.04 | 420.80 |
| −4.25 | −1.02 | 420.80 |
| −5.23 | −2.04 | 420.80 |
| −6.13 | −3.01 | 420.80 |
| −6.93 | −3.91 | 420.80 |
| −7.63 | −4.75 | 420.80 |
| −8.22 | −5.51 | 420.80 |
| −8.73 | −6.17 | 420.80 |
| −9.14 | −6.74 | 420.80 |
| −9.48 | −7.21 | 420.80 |
| −9.74 | −7.57 | 420.80 |
| −9.95 | −7.83 | 420.80 |
| −10.01 | −7.90 | 420.80 |
| −10.07 | −7.96 | 420.80 |
| −10.13 | −8.00 | 420.80 |
| −10.18 | −8.03 | 420.80 |
| −10.22 | −8.03 | 420.80 |
| −10.26 | −8.03 | 420.80 |
| −10.28 | −8.02 | 420.80 |
| −10.29 | −8.02 | 420.80 |
| −10.30 | −8.01 | 420.80 |

Radial section 99

| | | |
|---|---|---|
| −10.30 | −8.01 | 424.80 |
| −10.31 | −8.01 | 424.80 |
| −10.32 | −8.00 | 424.80 |
| −10.34 | −7.98 | 424.80 |
| −10.36 | −7.95 | 424.80 |
| −10.38 | −7.91 | 424.80 |
| −10.40 | −7.85 | 424.80 |
| −10.41 | −7.78 | 424.80 |
| −10.41 | −7.69 | 424.80 |
| −10.39 | −7.59 | 424.80 |
| −10.33 | −7.24 | 424.80 |
| −10.21 | −6.78 | 424.80 |
| −10.00 | −6.21 | 424.80 |
| −9.72 | −5.51 | 424.80 |
| −9.38 | −4.69 | 424.80 |
| −8.95 | −3.76 | 424.80 |
| −8.44 | −2.72 | 424.80 |
| −7.83 | −1.59 | 424.80 |
| −7.11 | −0.38 | 424.80 |
| −6.29 | 0.88 | 424.80 |
| −5.36 | 2.17 | 424.80 |
| −4.31 | 3.48 | 424.80 |
| −3.15 | 4.77 | 424.80 |
| −1.89 | 6.02 | 424.80 |
| −0.54 | 7.22 | 424.80 |
| 0.89 | 8.34 | 424.80 |
| 2.37 | 9.37 | 424.80 |
| 3.89 | 10.30 | 424.80 |
| 5.41 | 11.13 | 424.80 |
| 6.92 | 11.85 | 424.80 |
| 8.39 | 12.48 | 424.80 |
| 9.79 | 13.02 | 424.80 |
| 11.12 | 13.48 | 424.80 |
| 12.34 | 13.88 | 424.80 |
| 13.44 | 14.22 | 424.80 |
| 14.43 | 14.50 | 424.80 |
| 15.28 | 14.75 | 424.80 |
| 16.01 | 14.95 | 424.80 |
| 16.60 | 15.10 | 424.80 |
| 17.07 | 15.19 | 424.80 |
| 17.41 | 15.14 | 424.80 |
| 17.50 | 15.07 | 424.80 |
| 17.55 | 15.00 | 424.80 |
| 17.58 | 14.94 | 424.80 |
| 17.60 | 14.88 | 424.80 |
| 17.61 | 14.83 | 424.80 |
| 17.61 | 14.80 | 424.80 |
| 17.61 | 14.78 | 424.80 |
| 17.61 | 14.76 | 424.80 |
| 17.61 | 14.75 | 424.80 |
| 17.61 | 14.74 | 424.80 |
| 17.61 | 14.73 | 424.80 |
| 17.60 | 14.70 | 424.80 |
| 17.60 | 14.67 | 424.80 |
| 17.59 | 14.63 | 424.80 |
| 17.57 | 14.58 | 424.80 |
| 17.54 | 14.51 | 424.80 |
| 17.50 | 14.44 | 424.80 |
| 17.44 | 14.37 | 424.80 |
| 17.15 | 14.20 | 424.80 |
| 16.74 | 14.01 | 424.80 |
| 16.22 | 13.77 | 424.80 |
| 15.59 | 13.46 | 424.80 |
| 14.84 | 13.09 | 424.80 |
| 13.98 | 12.66 | 424.80 |
| 13.01 | 12.15 | 424.80 |
| 11.96 | 11.57 | 424.80 |
| 10.81 | 10.91 | 424.80 |
| 9.60 | 10.18 | 424.80 |
| 8.33 | 9.38 | 424.80 |
| 7.03 | 8.50 | 424.80 |
| 5.69 | 7.56 | 424.80 |
| 4.35 | 6.57 | 424.80 |
| 3.01 | 5.52 | 424.80 |
| 1.69 | 4.44 | 424.80 |
| 0.40 | 3.34 | 424.80 |
| −0.85 | 2.23 | 424.80 |
| −2.05 | 1.13 | 424.80 |
| −3.19 | 0.04 | 424.80 |
| −4.25 | −1.02 | 424.80 |
| −5.23 | −2.04 | 424.80 |
| −6.13 | −3.01 | 424.80 |
| −6.93 | −3.92 | 424.80 |
| −7.63 | −4.75 | 424.80 |
| −8.22 | −5.51 | 424.80 |
| −8.73 | −6.17 | 424.80 |
| −9.14 | −6.74 | 424.80 |
| −9.48 | −7.21 | 424.80 |
| −9.74 | −7.57 | 424.80 |
| −9.95 | −7.83 | 424.80 |
| −10.01 | −7.90 | 424.80 |
| −10.07 | −7.96 | 424.80 |
| −10.13 | −8.00 | 424.80 |
| −10.18 | −8.03 | 424.80 |
| −10.22 | −8.03 | 424.80 |
| −10.26 | −8.03 | 424.80 |
| −10.28 | −8.02 | 424.80 |
| −10.29 | −8.02 | 424.80 |
| −10.30 | −8.01 | 424.80 |

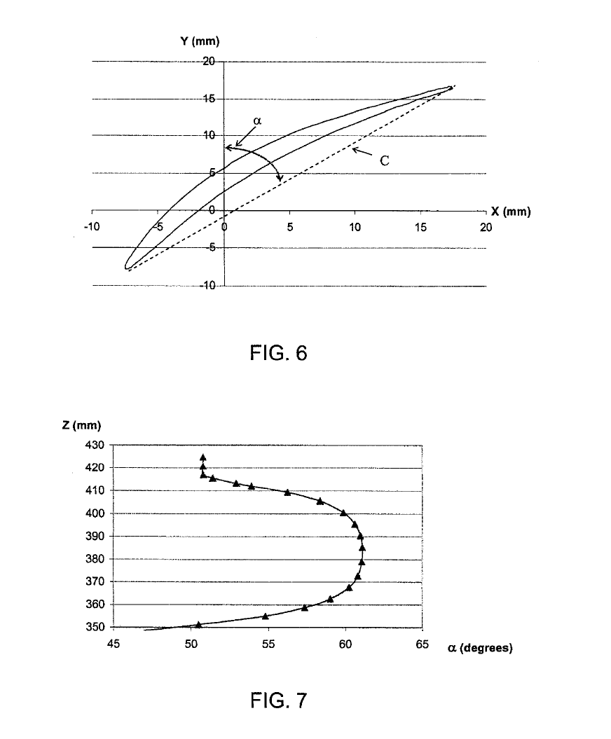

Another important geometric characteristic of the vane 2 is its setting angle. As illustrated in FIG. 6, the setting angle α corresponds to the direct angle formed by the chord C of the vane with the Y axis, for a given radial section, that is to say for a given value of Z. The graph in FIG. 7 shows, for the set of constituent Z values of the vane 2, the variation of the setting angle α. The setting angle defines the angle at which the stream of air coming from upstream of the turbomachine strikes the vane 2 and therefore has a direct influence on the quality with which the airstream is directed.

Starting from the coordinates of the set of points of a given radial section, this section may be reconstructed by joining these points by arcs linked together in a smooth and continuous manner within the mathematical meaning of the term. Once each radial section has been reconstructed, the vane 2 may be obtained in the same way, by joining together the various sections in a smooth and continuous manner. The reconstructed profile thus obtained corresponds to the vane under ambient temperature and pressure conditions, subjected to no force. Moreover, this reconstructed profile does not take into account the possible presence of a coating. It corresponds to a vane 2 whose overall dimensions are the nominal dimensions. It is therefore necessary to take into account the manufacturing tolerances, namely ±0.10 mm, which are added to or subtracted from the X and Y coordinates given in table 1. By taking these tolerances into account, two envelopes surrounding the reconstructed profile may be defined, one to the outside and the other to the inside. These two envelopes represent a possible range of variation between the actually measured constituent points on the vane 2 and the points on the nominal profile. As long as the measured profile of the vane 2 remains within these two envelopes, no deleterious effect of the variation in the profile geometry on the mechanical and aerodynamic characteristics of the vane occurs.

The nominal aerodynamic profile as defined in table 1 corresponds to the preferred embodiment of the invention. In this embodiment, the vane, with a total height of 67 mm, extends between the heights Z=350.23 mm and Z=417.57 mm. The setting angle α is between 48.6° and 61.1°. The radius of curvature of the trailing edge of the radially inner part 2a is around 0.2 mm, reaching 0.5 mm in the joining part 2b. In the area 20, the thickness of the vane toward the TE on the pressure surface side is increased over one third of the chord C and over 2.3 mm, i.e. about 3.4% of the height of the vane.

1. A turbomachine guide vane, the vane having an aerodynamic profile and a stacking axis, wherein the turbomachine having a rotation axis, the vane consists of a plurality of radial sections made orthogonally to its stacking axis, each radial section being composed of points whose Cartesian coordinates X, Y and Z are as defined in Table 1, the Z coordinate corresponding to the distance between a radial section in question and the turbomachine rotation axis, X and X and Y corresponding to the coordinates in the plane comprising the section in question of the points forming this section, the X axis being parallel to the turbomachine rotation axis, the X values increasing in the turbomachine gas flow direction, the origin of the X axis being located at its intersection with the Z axis, the Y axis being such that the (X,Y,Z) reference frame is a direct orthogonal frame.

2. The guide vane as claimed in claim 1, wherein each radial section has a center of gravity, the X and Y Cartesian coordinates of which are given in FIG. 5.

3. The guide vane as claimed in either of claims 1 and 2, wherein each radial section has a leading edge and a trailing edge, the value of the direct angle formed by the straight line joining the leading edge to the trailing edge and the Y axis following the curve given in FIG. 7.

4. The guide vane as claimed in any one of claims 1 to 3, wherein, for each radial section, the X and Y coordinates of the points making up the section lie within a ±0.10 mm range with respect to the values defined in Table 1.

5. A guide vane ring sector comprising an inner shroud, an outer shroud and at least one vane as claimed in any one of claims 1 to 4.

6. A compression stage comprising a ring of guide vane ring sectors and a rotor wheel fitted with moving blades, the ring of guide vane ring sectors comprising at least one guide vane ring sector as claimed in claim 5.

7. A compressor comprising at least one compression stage as claimed in claim 6.

8. A turbomachine comprising at least one compressor as claimed in the preceding claim.
